(19) United States
(12) Patent Application Publication
(10) Pub. No.: US 2025/0001724 A1
(43) Pub. Date: Jan. 2, 2025

(54) REINFORCED FLOORING AND FLOORING PANELS WITH AMORPHOUS MATERIALS

(71) Applicant: HANWHA AZDEL, INC., Forest, VA (US)

(72) Inventors: Troy D Robertz, Forest, VA (US); Peter T Evers, JR., Forest, VA (US); Joseph Dumeah, Forest, VA (US); Arturo Lopez, Forest, VA (US)

(21) Appl. No.: 18/629,413

(22) Filed: Apr. 8, 2024

Related U.S. Application Data
(60) Provisional application No. 63/457,889, filed on Apr. 7, 2023.

(51) Int. Cl. B32B 5/24; B32B 5/12; B32B 5/18; B32B 7/12

(52) U.S. Cl. CPC B32B 5/245; B32B 5/12; B32B 5/18; B32B 7/12; B32B 2260/023; B32B 2260/046; B32B 2266/0228; B32B 2266/0264; B32B 2266/0278; B32B 2307/718

(57) ABSTRACT

Thermoplastic composite articles are described that comprise one or more fiber reinforcement layers that includes an amorphous material. In certain arrangements, the thermoplastic composite article can include a reinforcement layer, a porous layer, a core layer and an optional support layer. The articles can be used in flooring or as other articles or structures.

### PRIORITY APPLICATION

This application is related to and claims priority to and the benefit of U.S. Provisional Application No. 63/457,889 filed on Apr. 7, 2023, the entire disclosure of which is hereby incorporated herein by reference for all purposes.

### TECHNOLOGICAL FIELD

Impact resistant flooring and floor panels are described. In some configurations, the flooring and flooring panels include lightweight fiber reinforcement layers that include an amorphous material.

### BACKGROUND

Composite articles often include various materials that impart desired properties to the articles. Many composite articles are subject to impacts that can damage the article and reduce the lifetime of the article.

### SUMMARY

Certain aspects and features are described in reference to composite articles that can be used in flooring, flooring panels and other applications. The exact make-up of the articles may vary and typically the articles include a fiber reinforcement layer comprising an amorphous material in combination with a core layer and/or one or more porous layers and skin layers. The resulting article can provide impact resistance in the use environment of the article.

In an aspect, a thermoplastic composite article comprises a core layer comprising a foam material, a porous layer comprising a web of reinforcing fibers held in place by a thermoplastic material, wherein the porous layer is disposed on a first surface of the core layer, and a fiber reinforcement layer assembly disposed on the porous layer, wherein the fiber reinforcement layer assembly comprises a matrix comprising a plurality of arranged fibers held in place by an amorphous thermoplastic material.

In certain embodiments, the plurality of arranged fibers of the fiber reinforcement layer assembly comprise a unidirectional arrangement of the fibers in a single ply, two plys, three plys, four plys, five plys, six plys or more than six plys. In other embodiments, the plurality of arranged fibers of the fiber reinforcement layer assembly are selected from the group consisting of glass fibers, carbon fibers, organic fibers, inorganic fibers, bicomponent fibers, and combinations and blends thereof.

In some configurations, the plurality of arranged fibers of the fiber reinforcement layer assembly comprise a bidirectional arrangement of the fibers in a single ply, a bidirectional arrangement of the fibers in two plys, a bidirectional arrangement of the fibers in three plys, a bidirectional arrangement of the fibers in four plys, a bidirectional arrangement of the fibers in five plys, a bidirectional arrangement of the fibers in six plys or a bidirectional arrangement of the fibers in more than six plys In other configurations, the plurality of arranged fibers of each ply are independently selected from the group consisting of glass fibers, carbon fibers, organic fibers, inorganic fibers, bicomponent fibers and combinations and blends thereof.

In certain embodiments, the fiber reinforcement layer assembly comprises a basis weight between 400 gsm and 4000 gsm. In some embodiments, the fiber reinforcement layer assembly comprises four plys comprising a 0/90/90/0 arrangement of the plurality of the arranged fibers.

In other embodiments, the thermoplastic material of the each of the four plys of the fiber reinforcement layer assembly each is independently an amorphous polyethylene terephthalate or an amorphous polyolefin.

In additional embodiments, the thermoplastic material of the porous layer comprises at least one of a polyethylene, a polypropylene, a polystyrene, a polyimide, a polyetherimide, an acrylonitrylstyrene, a butadiene, a polyethylene terephthalate, a polybutyleneterephthalate, a polybutylenetetrachlorate, a polyvinyl chloride, a polyphenylene ether, a polycarbonate, a polyestercarbonate, a polyester, an acrylonitrile-butylacrylate-styrene polymer, an amorphous nylon, a polyarylene ether ketone, a polyphenylene sulfide, a polyaryl sulfone, a polyether sulfone, a poly(1,4 phenylene) compound, a silicone and mixtures thereof.

In some configurations, the reinforcing fibers of the porous layer are selected from the group consisting of glass fibers, carbon fibers, graphite fibers, synthetic organic fibers, inorganic fibers, bicomponent fibers, natural fibers, mineral fibers, metal fibers, metalized inorganic fibers, metalized synthetic fibers, ceramic fibers, and combinations and blends thereof.

In certain embodiments, the thermoplastic composite article further comprises a second porous layer between the core layer and the porous layer. In some configurations, a first adhesive layer is present between the fiber reinforcement layer assembly and the porous layer and an optional second adhesive layer is present between the porous layer and the core layer. In some arrangements, each of the first adhesive layer and the second adhesive layer comprises a polyolefin.

In other embodiments, the plurality of arranged fibers of the fiber reinforcement layer assembly comprise a unidirectional arrangement of the fibers in a single ply, a bidirectional arrangement of fibers in two plys, a bidirectional arrangement of fibers in three plys, a bidirectional arrangement of fibers in four ply, or a bidirectional arrangement of fibers in more than four plys. In some configurations, the plurality of arranged fibers of the skin are selected from the group consisting of glass fibers, carbon fibers, organic fibers, inorganic fibers, bicomponent fibers, and combinations and blends thereof.

In certain embodiments, the foam material of the core layer comprises an expandable foam, an expandable polyurethane foam, or an expandable polystyrene foam. In other embodiments, the foam material of the core layer comprises a high density polyethylene terephthalate foam.

In some embodiments, the thermoplastic composite article comprises a support layer coupled to a second surface of the core layer. In some configurations, the support layer comprises a metal layer, a porous layer, a glass mat, a flame retardant panel, a scrim, or a fiber reinforcement layer assembly.

In certain embodiments, the amorphous thermoplastic material of the fiber reinforcement layer assembly is polyolefin free.

In another aspect, a flooring panel comprises a core layer comprising a foam material, a porous layer comprising a web of reinforcing fibers held in place by a thermoplastic material, wherein the porous layer is disposed on a first surface of the core layer, a fiber reinforcement layer assembly disposed on the porous layer, wherein the fiber reinforcement layer assembly comprises a matrix comprising a plurality of arranged fibers held in place by an amorphous thermoplastic material, and a support layer coupled to a second surface of the core layer. In certain embodiments, the flooring panel deflects less than 50 mm, less than 40 mm, less than 30 mm, less than 20 mm or less than 10 mm under a 500 pound knee load test.

In certain configurations, the support layer comprises a porous layer comprising a web of reinforcing fibers held in place by a thermoplastic material, wherein the porous layer is disposed on a first surface of the core layer and a film disposed on the porous layer.

In other configurations, the amorphous thermoplastic material of the fiber reinforcement layer assembly is an amorphous polyolefin or an amorphous polyethylene terephthalate.

In certain embodiments, the flooring panel comprises an adhesive layer between the fiber reinforcement layer assembly and the porous layer. In some embodiments, the adhesive layer comprises a thermoplastic material or a thermosetting material. In other embodiments, the thermoplastic material of the adhesive layer comprises a polyolefin.

In certain embodiments, the plurality of arranged fibers of the fiber reinforcement layer assembly comprise a unidirectional arrangement of the fibers in a single ply, a unidirectional arrangement of the fibers in at least two plys, a bidirectional arrangement of fibers in two plys, a bidirectional arrangement of fibers in three plys, a bidirectional arrangement of fibers in four plys or a bidirectional arrangement of fibers in more than four plys. In other embodiments, the plurality of arranged fibers of the fiber reinforcement layer assembly are selected from the group consisting of glass fibers, carbon fibers, organic fibers, inorganic fibers, bicomponent fibers, and combinations and blends thereof.

In certain embodiments, the porous layer comprises a basis weight between 500 gsm and 2000 gsm.

In other embodiments, the fiber reinforcement layer assembly comprises a plurality of arranged glass fibers held in place by an amorphous thermoplastic polyethylene terephthalate.

In some configurations, the support layer comprises a metal layer, a porous layer, a glass mat, a flame retardant panel, a scrim, or a fiber reinforcement layer assembly.

Additional aspects, embodiments, configurations, examples, features and elements are described in more detail below.

### BRIEF DESCRIPTION OF THE SEVERAL VIEWS OF THE DRAWINGS

Certain specific illustrations are described in reference to the accompanying figures in which:

FIG. 1 is an illustration of an article including a core layer, a porous layer and a fiber reinforcement layer, in accordance with certain embodiments;

FIG. 2 is another illustration of an article including a core layer, a porous layer and a fiber reinforcement layer, in accordance with certain embodiments;

FIG. 3 is a three-dimensional illustration showing a fiber reinforcement layer with a 0 degree angle fiber arrangement, in accordance with certain embodiments;

FIG. 4 is a three-dimensional illustration showing a fiber reinforcement layer with a 90 degree angle fiber arrangement, in accordance with certain embodiments;

FIG. 5 is an illustration showing a fiber reinforcement layer with a 45 degree angle fiber arrangement, in accordance with certain embodiments;

FIG. 6 is an illustration showing a fiber reinforcement layer with differently angled fiber arrangements, in accordance with certain embodiments;

FIG. 7 is an illustration showing a fiber reinforcement layer with different fiber densities at different areas, in accordance with certain embodiments;

FIG. 8 is an illustration showing a fiber reinforcement layer with different fiber densities and different fiber angles at different areas, in accordance with certain embodiments;

FIG. 9 is another illustration showing a fiber reinforcement layer with different fiber densities and different fiber angles at different areas, in accordance with certain embodiments;

FIG. 10 is an illustration showing a two-ply arrangement of 0/0 angled fibers, in accordance with certain embodiments;

FIG. 11 is an illustration showing a two-ply arrangement of 90/0 angled fibers, in accordance with certain embodiments;

FIG. 12 is an illustration showing a two-ply arrangement of 45/0 angled fibers, in accordance with certain embodiments;

FIG. 13 is an illustration showing a two-ply arrangement of 45/45 angled fibers, in accordance with certain embodiments;

FIG. 14 is an illustration showing a three-ply arrangement of angled fibers, in accordance with certain embodiments;

FIG. 15 is an illustration showing a four-ply arrangement of angled fibers, in accordance with certain embodiments;

FIG. 16 is an illustration showing a composite article including a core layer, a porous layer, a fiber reinforcement layer and a skin layer, in accordance with certain embodiments;

FIG. 17 is an illustration showing a composite article including a core layer, a porous layer, a fiber reinforcement layer, an adhesive layer and a skin layer, in accordance with certain embodiments;

FIG. 18 is an illustration showing a composite article including a core layer, a porous layer, a fiber reinforcement layer, adhesive layers and a skin layer, in accordance with certain embodiments;

FIG. 19 is an illustration showing a composite article including a core layers, a porous layer, a fiber reinforcement layer, adhesive layers and a skin layer, in accordance with certain embodiments;

FIG. 20 is an illustration showing a composite article including a core layer, a porous layer, a fiber reinforcement layer, a decorative layer and a skin layer, in accordance with certain embodiments;

FIG. 21 is an illustration showing a composite article including a core layer, two porous layers, a fiber reinforcement layer, and a skin layer, in accordance with certain embodiments;

FIG. 22 is an illustration showing a composite article including two core layers, a porous layer, a fiber reinforcement layer, a decorative layer and a skin layer, in accordance with certain embodiments;

FIG. 23 is an illustration showing three flooring panels, in accordance with certain embodiments;

FIG. 24 is another illustration showing three flooring panels, in accordance with certain embodiments;

FIG. 25 is an illustration showing an RV floor, in accordance with certain embodiments;

FIG. 26 is an illustration showing a composite article including a reinforcement, layer, two porous layers, a core layer and a skin layer, in accordance with certain embodiments;

FIG. 27 is an illustration of a cabover truck, in accordance with certain embodiments;

FIG. 28 is an illustration showing a shed, in accordance with certain embodiments;

FIG. 29 is an illustration of a hunting blind, in accordance with certain examples;

FIG. 30 is an illustration of a portable shelter, in accordance with certain examples;

FIG. 31 is an illustration of a structural panel, in accordance with certain embodiments;

FIG. 32 is another illustration of a structural panel, in accordance with certain embodiments;

FIG. 33 is an illustration of a wall panel, in accordance with certain examples;

FIG. 34 is an illustration of a siding panel, in accordance with certain examples;

FIG. 35 is an illustration of a roofing panel, in accordance with certain embodiments;

FIG. 36 is an illustration of a roofing shingle, in accordance with certain embodiments;

FIG. 37 is an illustration of an interior panel of a recreational vehicle, in accordance with certain embodiments;

FIG. 38 is an illustration of an exterior panel of a recreational vehicle, in accordance with certain embodiments; and

FIG. 39 is an illustration of an interior trim, in accordance with certain embodiments.

It will be recognized by the person having ordinary skill in the art, given the benefit of this disclosure, that the dimensions, sizes, shading, arrangement and other features in the figures are provided merely for illustration and are not intended to limit the technology to any one configuration, dimension or arrangement. Each layer need not have the same thickness or dimensions as the other layers, even though certain figures may show similar thicknesses or dimensions for ease or illustration.

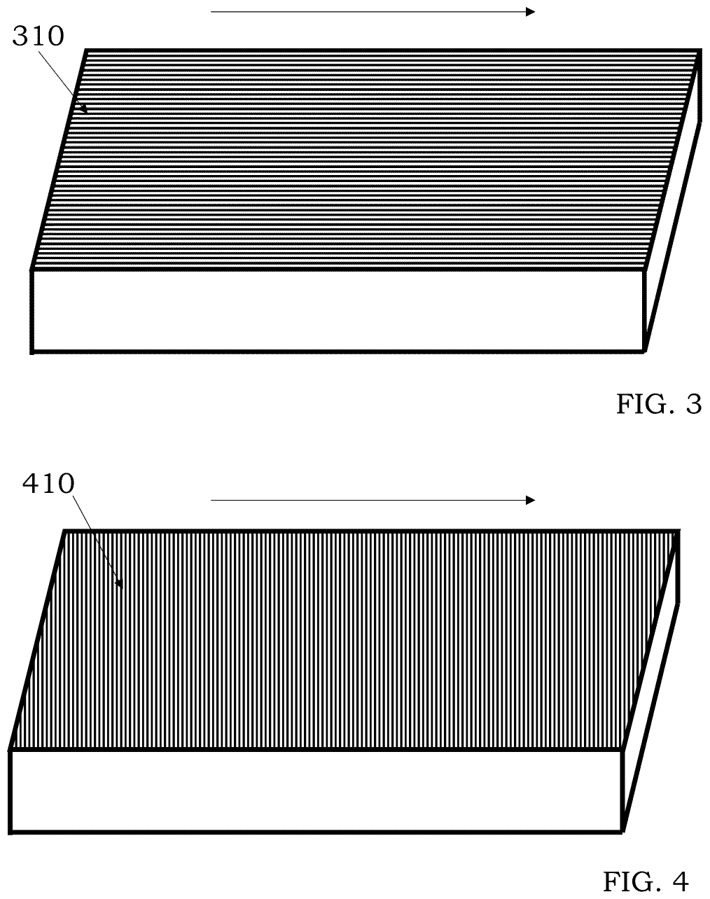

In a typical arrangement, the fibers of the reinforcement layers are oriented in a particular direction/angle when viewed from a top surface of the reinforcement layer. FIG. 3 and FIG. 4 shows a three-dimensional view of the fiber arrangement. For ease of illustration, the other figures show a two-dimensional arrangement where the fiber orientation is intentionally shown for context. The skilled person, given the benefit of this disclosure, will understand that the fiber arrangement shown in two-dimensional representations is actually the same arrangement shown in FIG. 3 or FIG. 4 when viewed from the top surface of the particular fiber reinforcement layer.

### DETAILED DESCRIPTION

Various components and features of composite articles used in flooring and flooring panels that include fiber reinforcement layers comprising amorphous materials are discussed. The exact arrangement and number of materials or layers may vary depending on the particular intended use of the composite article.

In certain configurations, the composite articles described herein generally include a fiber reinforcement layer comprising an amorphous material in combination with a porous layer and a core layer, which can be porous or non porous, and optionally other layers. Without wishing to be bound by any one configuration, the amorphous material in the fiber reinforcement layer can result in reduced absorption of the amorphous material into the porous layer. This result can permit increased adhesion between the various layers of the composite article. In addition, the fiber reinforcement layer can provide impact resistance to the article. Illustrative amorphous materials and their properties are discussed in more detail below. Impact resistance can be measured in numerous manner including a gravelometer test, falling weight test, knee load test or other tests. A gravelometer test is described in SAE Standard J400 dated Oct. 23, 2012, which is similar to ASTM D3170-14 dated Jul. 1, 2014. For example, the materials can be used to produce a composite article that can withstand 50 or more individual impacts, e.g., 100 or more individual impacts, as provided under the gravelometer test conditions, without any substantial damage or effects to the article. The composite article can be tested according to the SAE J400 test and may be considered to pass the test if the number of impact cycles exceeds a desired value, e.g., greater than or equal to 50 impacts by individual stones, gravels or equivalent flying objects, greater than or equal to 100 impacts by individual stones, gravels or equivalent flying objects, greater than or equal to 200 impacts by individual stones, gravels or equivalent flying objects, or greater than or equal to 300 impacts by individual stones, gravels or equivalent flying objects. In the test procedure, sample plaques of 100 mm×300 mm can be placed in a holder with the back side supported against a steel plate. Stones can be projected at the plaques at 90 degrees or perpendicular to the surface. The stones can be water eroded alluvial road gravel 8 to 16 mm in size. Stones can be fed through the air stream with an 8+2 seconds interval at an air pressure of 70 psi. Every 10 cycles the specimen can be taken out for observation. Any cracking, blistering, delamination, or erosion through the outer surface indicates failure. The test can be continued until any of the above mentioned failure is observed. In other instances, impact resistance can be measured according to other tests including, but not limited to, ASTM D5420-21 (falling weight impact test), ASTM D2794-1993 (R2019) (falling weight from various heights) or other tests which can subject a surface to impact, indenting or falling weight. If desired, impact resistance can be measured using a knee load test. As used herein, a “knee load test” refers to a test where a load is applied until the sample fails or up until 500 pounds of total weight is applied (whichever occurs first). An amount the sample defects is measured and recorded. For example and by way of illustration only, under a knee load test a sample might deflect 6 mm under a 500 pound load without failing, or a sample may fail at 26 mm deflection under a 425 pound load.

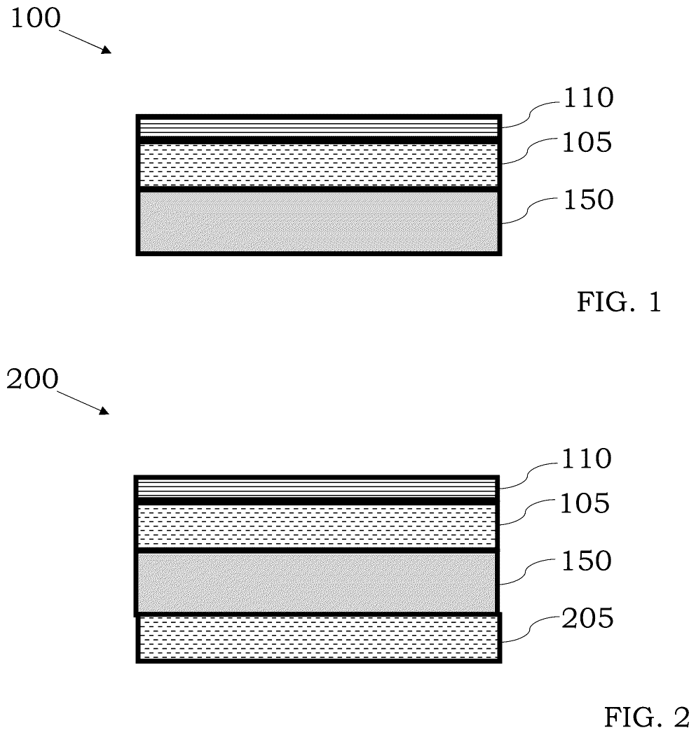

Referring now to FIG. 1, an illustration of a composite article 100 is shown that comprises a fiber reinforcement layer 110 on a porous layer 105. The porous layer 105 is on a core layer 150. As shown in the article 200 of FIG. 2, an additional layer or skin layer 205 can be present on another surface of the core layer 150. In certain embodiments, the core layer 150 may be porous. In some embodiments, the core layer 150 is a porous core layer comprising a web of open celled structures comprising random crossing over of a plurality of reinforcing fibers held together by a thermoplastic material. The porous layer 105 may also comprise a web of open celled structures comprising random crossing over of a plurality of reinforcing fibers held together by a thermoplastic material. The materials in the layers 105, 150 can be the same or can be different. The porous layer 105 and the core layer 105 can independently have a porosity that can vary from more than 0% by volume up to about 95% by volume of the porous layer. For example, the porous layer 105 and the core layer 150 may each comprise a void content or porosity of 0-30%, 10-40%, 20-50%, 30-60%, 40-70%, 50-80%, 60-90%, 0-40%, 0-50%, 0-60%, 0-70%, 0-80%, 0-90%, 10-50%, 10-60%, 10-70%, 10-80%, 10-90%, 10-95%, 20-60%, 20-70%, 20-80%, 20-90%, 20-95%, 30-70%, 30-80%, 30-90%, 30-95%, 40-80%, 40-90%, 40-95%, 50-90%, 50-95%, 60-95% 70-80%, 70-90%, 70-95%, 80-90%, 80-95% by volume of the particular layer or any illustrative value within these exemplary ranges.

In certain embodiments, the thermoplastic material of the layers 105, 150 can include polyolefin and/or non-polyolefin materials. For example, the thermoplastic material of the core layer 105 comprises one or more of a polyolefin (e.g., one or more of polyethylene, polypropylene, etc.), polystyrene, acrylonitrylstyrene, butadiene, polyethylene-terephthalate, polybutyleneterephthalate, polybutylenetetrachlorate, and polyvinyl chloride, both plasticized and unplasticized, and blends of these materials with each other or other polymeric materials. Other suitable thermoplastics include, but are not limited to, polyarylene ethers, polycarbonates, polyestercarbonates, thermoplastic polyesters, polyimides, polyetherimides, polyamides, co-polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as copolymers, alloys and blends of these materials with each other or other polymeric materials. The thermoplastic material used to form the layer 105 or the layer 150 can be used in powder form, resin form, rosin form, particle form, fiber form or other suitable forms. Illustrative thermoplastic materials in various forms are described herein and are also described, for example in U.S. Publication Nos. 20130244528 and US20120065283. The exact amount of thermoplastic material present in the core layer can vary and illustrative amounts range from about 20% by weight to about 80% by weight, e.g., 30-70 percent by weight or 35-65 percent by weight, based on the total weight of the layer 105 or the layer 150. It will be recognized by the skilled person that the weight percentages of all materials used in the core layer 105 will add to 100 weight percent.

In certain configurations, the reinforcing fibers in the porous layer 105 or the core layer 150 can include organic reinforcing fibers, inorganic reinforcing fibers or combinations or blends thereof. For example, the reinforcing fibers in the porous layer 105 and the core layer 150 may comprise glass fibers, carbon fibers, graphite fibers, synthetic organic fibers, particularly high modulus organic fibers such as, for example, para-and meta-aramid fibers, nylon fibers, polyester fibers, natural fibers, cellulose fibers, a high melt flow index resin (e.g., 100 g/10 min. MFI, 325 g/10 min. MFI or above) that is suitable for use as fibers, mineral fibers such as basalt, mineral wool (e.g., rock or slag wool), wollastonite, alumina silica, and the like, or mixtures thereof, metal fibers, metalized natural and/or synthetic fibers, ceramic fibers, yarn fibers, or mixtures thereof. In certain embodiments, the fibers used may be cellulose free to avoid or reduce the likelihood of mold or other microbial growth. In some embodiments, the fibers in the porous layer 105 or the core layer 150 can be bi-component fibers, e.g., core-sheath fibers, as described for example, in U.S. Patent Publication No. 20180162107 published on Jun. 14, 2018. In some embodiments, any of the aforementioned fibers can be chemically treated prior to use to provide desired functional groups or to impart other physical properties to the fibers, e.g., may be chemically treated so that they can react with the thermoplastic material, the reproduced polymeric fibers or both. The reinforcing fiber content in the porous layer 105 or the core layer 150 may vary from about 10% to about 90% by weight of the core layer, more particularly from about 20% to about 80% by weight, e.g., about 30% to about 70% by weight of the particular layer. The particular size and/or orientation of the fibers used may depend, at least in part, on the thermoplastic material used and/or the desired properties of the layer 105 and the layer 150. For example, the reinforcing fibers can be randomly oriented or may have a specific selected orientation as desired. In one non-limiting illustration, reinforcing fibers dispersed within a thermoplastic material and optionally other additives to provide the layers 105, 150 can generally have a diameter of greater than about 5 microns, more particularly from about 5 microns to about 22 microns, and a length from about 5 mm to about 200 mm, more particularly, the fiber diameter may be from about 2 microns to about 22 microns and the fiber length may be from about 5 mm to about 75 mm.

In some embodiments, other additives or materials may also be present in the layer 105 or the layer 150. For example, a lofting agent, flame retardants, colorants, smoke suppressants, surfactants, foams or other materials may be present. In some examples, one or both of the layers 105, 150 may substantially halogen free or halogen free core layer to meet the restrictions on hazardous substances requirements for certain applications. In other instances, the porous layer 105 and the core layer 150 may comprise a halogenated flame retardant agent such as, for example, a halogenated flame retardant that comprises one of more of F, Cl, Br, I, and At or compounds that including such halogens, e.g., tetrabromo bisphenol-A polycarbonate or monohalo-, dihalo-, trihalo- or tetrahalo-polycarbonates. In some instances, the thermoplastic material used in the layer 105 and the layer 150 may comprise one or more halogens to impart some flame retardancy without the addition of another flame retardant agent. Where halogenated flame retardants are present, the flame retardant is desirably present in a flame retardant amount, which can vary depending on the other components which are present. For example, the halogenated flame retardant may be present in about 0.1 weight percent to about 15 weight percent (based on the weight of the core layer), more particularly about 1 weight percent to about 15 weight percent, e.g., about 5 weight percent to about 15 weight percent based on the weight of the core layer. If desired, two different halogenated flame retardants may be added to the layers. In other instances, a non-halogenated flame retardant agent such as, for example, a flame retardant agent comprising one or more of N, P, As, Sb, Bi, S, Se, and Te can be added. In some embodiments, the non-halogenated flame retardant may comprise a phosphorated material so the layers may be more environmentally friendly. Where non-halogenated or substantially halogen free flame retardants are present, the flame retardant is desirably present in a flame retardant amount, which can vary depending on the other components which are present. For example, the substantially halogen free flame retardant may be present in about 0.1 weight percent to about 15 weight percent (based on the weight of the layer), more particularly about 1 weight percent to about 15weight percent, e.g., about 5 weight percent to about 15 weight percent based on the weight of the core layer. If desired, two different substantially halogen free flame retardants may be added to one or more of the core layers described herein. In certain instances, one or more of the porous layers or core layers described herein may comprise one or more halogenated flame retardants in combination with one or more substantially halogen free flame retardants. Where two different flame retardants are present, the combination of the two flame retardants may be present in a flame retardant amount, which can vary depending on the other components which are present. For example, the total weight of flame retardants present may be about 0.1 weight percent to about 20 weight percent (based on the weight of the layer), more particularly about 1 weight percent to about 15 weight percent, e.g., about 2 weight percent to about 14 weight percent based on the weight of the core layer. The flame retardant agents used in the layers described herein can be added to the mixture comprising the thermoplastic material and fibers (prior to disposal of the mixture on a wire screen or other processing component) or can be added after the porous layer 105 or the core layer 150 is formed. In some examples, the flame retardant material may comprise one or more of expandable graphite materials, magnesium hydroxide (MDH) and aluminum hydroxide (ATH).

In some embodiments, a lofting capacity of the layer 105 and the layer 150 can be tuned by including one or more added lofting agents in the porous layer 105 or the layer 150. The exact type of lofting agent used in the porous layer 105 or the core layer 150 can depend on numerous factors including, for example, the desired lofting temperature, the desired degree of loft, etc. In some instances, microsphere lofting agents, e.g., expandable microspheres, which can increase their size upon exposure to convection heating may be used. Illustrative commercially available lofting agents are available, for example, from Kureha Corp. (Japan). In other examples, the lofting agent may be an expandable graphite material or a combination of a microsphere lofting agent with a non-microsphere lofting agent.

In other configurations, the core layer 150 may be non-porous or closed cell. For example, the core layer 150 may be configured similar to the porous layer described herein, where the thermoplastic material is an amorphous thermoplastic material. In other instances, the core layer 150 may comprise one or more foams, e.g., an open cell foam or a closed cell foam. In certain configurations, closed cell foams may be desirable to provide some insulation properties and higher strength. The exact type of foam used may vary and illustrative foams include, but are not limited to, expanded (or expandable) foam material, an extruded foam or a cast foam. Without wishing to be bound by any one configuration, expandable foams generally expand to occupy a volume of a mold, container or other area. The expandable foam can be based on polystyrene, polyethylene, polypropylene, polyurethane, polyisocyanate or other materials. In some embodiments, the expandable foam cam be an expandable polystyrene foam, an expandable polyethylene foam or an expandable polypropylene foam. In other embodiments, the foam can be a directionally compressive foam, e.g., a closed cell directionally compressive foam, including, but not limited to, a directionally compressive expanded polystyrene foam, a directionally compressive extruded polyethylene foam or a directionally compressive expandable polypropylene foam. In other instances, the foam may be based on a thermoplastic material including, but not limited to, polyester foams, a high density polyethylene terephthalate foam or other types of foams that can be open or closed cell. While the foam may be formed from various materials, the foam is typically used in board form and coupled to the porous layer through one or more adhesive layers. For example, the core layer comprising the foam material can be sized and arranged to mirror the size of the porous layer, e.g., both the core layer 150 and the porous layer 105 can be 4 feet by 8 feet.

In certain embodiments, the articles described herein can include a fiber reinforcement layer disposed on a surface of the porous layer. In embodiments where the article is configured as flooring or a panel, the fiber reinforcement layer is typically present on an outer surface or facing toward a use environment to provide impact resistance. While the reinforcement layer 110 is shown in FIGS. 1 and 2 as a single layer for illustration purposes, the reinforcement layer 110 make take the form of a single ply, two plys, three ply, four ply, five plys, six plys, etc. Each ply can be laminated individually to the porous layer, multiple plys may be stacked on the porous layer and then lamination may occur, or multiple plys can be laminated to each other prior to addition, and subsequent lamination, of the ply assembly to a porous layer.

In certain embodiments, the fiber reinforcement layer 110 can include fibers oriented in certain directions. The exact orientation of the fibers may vary and is often described with reference to a machine direction. For example, a machine direction can be the direction in which the porous layer is moving along a support structure during production of the porous layer. As noted herein, the fiber reinforcement layer 110 is typically laminated to the porous layer after or during production of the porous layer. A “0” degree orientation of the fibers is when the fibers are parallel (when viewed from the top of the layer) to the machine direction (as shown by the large arrow in FIG. 3). The fibers need not be completely parallel but instead the angle may vary up to about 5 degrees and the fibers would still be considered substantially parallel to the machine direction. FIG. 3 shows a zero degree orientation of the reinforcing fibers in a reinforcement layer 310. This top view shows the fibers are parallel to the machine direction. The exact type of fibers present in the layer 310 include, but are not limited to, organic reinforcing fibers, inorganic reinforcing fibers, glass fibers, carbon fibers, aramid fibers, metal fibers and combinations or blends thereof. In some embodiments, the fibers may be present as single continuous fibers, whereas in other instances the fibers can be present as long fiber bundles that run from one side of the layer 310 to another side of the layer 310.

In some configurations, the exact fiber density/amount in the layer 310 may vary. In a typical configuration, the fibers are held in the layer 310 by way of an amorphous binder or other amorphous materials that can retain the fiber orientation. In certain embodiments, the layer 310 may have a basis weight from about 100 gsm to about 800 gsm, for example, about 200 gsm to about 600 gsm or about 300 gsm to about 550 gsm. An overall thickness of the layer 310 can vary from about 0.1 mm to about 4 mm, more particularly about 0.2 mm to about 2 mm, e.g., about 0.3 mm to about 1.5 mm. The exact amount of binder and fibers can vary as desired. The fibers need not be present in a uniform amount across the surface of the layer 310. For example, edges of the layer 310 may include a higher or lower amount of fibers than fibers present at a central area of the layer 310. Materials other than the reinforcement fibers and the binder may also be present in the layer 310. For example, colorants, dyes, elastomers, flame retardant agents, powders, fillers, whiskers, texturizing agents, crystals, particles and the like can be present in the layer 310 as desired.

In some embodiments, the binder of the layer 310 may be an amorphous material. In general, amorphous materials, or materials with amorphous phases, do not have a sharp melting point when heated. Instead, amorphous materials become less solid and more elastic over a temperature range and are often defined by an average glass transition temperature rather than a specific melting point. Where an amorphous material is present in the layer 310, the average glass transition temperature of the amorphous material can be the same as or can be higher than a melting point of the thermoplastic material present in the core layer 105. Where the average glass transition temperature of the amorphous material is the same as the melting point of the thermoplastic material, the layer 310 can “melt” into the porous layer to some degree, which can act to adhere the layer 310 to the porous layer 105. In other configurations as noted below, an adhesive layer may be present between the porous layer 105 and the reinforcement layer. In some embodiments, the amorphous material of the layer 310 may be an amorphous thermoplastic material, an amorphous polyolefin material, an amorphous polyester material, an amorphous polyethylene terephthalate material, an amorphous polyurethane material, or combinations or blends thereof. Illustrative specific amorphous binder materials that can be present in the layer 310 include, but are not limited to, amorphous polyethylene, amorphous polypropylene, amorphous polyethylene terephthalate, amorphous polystyrene, amorphous polycarbonate, amorphous polysulfone, amorphous polyetherimide, amorphous polymethyl methacrylate, amorphous acrylonitrile butadiene styrene and combinations or blends thereof. If desired, the binder can include a combination of amorphous materials and non-amorphous materials. In some examples, the binder can be a non-amorphous material such as, for example, a polyolefin, polypropylene, PET, PVC, a polyurethane, a UV curable resin, a vinyl ester, an epoxy resin or epoxy material or other non-amorphous materials.

In certain configurations, the fibers of a fiber reinforcement layer can be arranged at a 90 degree orientation. Referring to FIG. 4, a fiber arrangement is shown where the fibers in a fiber reinforcement layer 410 (when viewed from the top of the layer 410) are oriented 90 degrees or orthogonal to the machine direction (as shown by the large arrow in FIG. 4). A 90 degree arrangement of the fibers is an average arrangement with the exact angle varying by +/−5 degrees. The 90 degree fibers are also oriented substantially parallel to a cross direction, which itself is 90 degrees to the machine direction. The exact type of fibers present in the layer 410 include, but are not limited to, organic reinforcing fibers, inorganic reinforcing fibers, glass fibers, carbon fibers, aramid fibers, metal fibers and combinations or blends thereof. In some embodiments, the fibers may be present as single continuous fibers, whereas in other instances the fibers can be present as long fiber bundles that run from one side of the layer 410 to another side of the layer 410.

In some configurations, the exact fiber density/amount in the layer 410 may vary. As noted below, some configurations used multiple layers or plys each of which includes reinforcing fibers. The fiber density in different layers can be the same or can be different. In a typical configuration, the fibers are held in the layer 410 by way of an amorphous binder or other amorphous materials that can retain the fiber orientation. In certain embodiments, a basis weight of the layer 410 may vary from about 100 gsm to about 800 gsm, more particularly about 200 gsm to about 600 gsm, e.g., about 300 gsm to about 550 gsm. An overall thickness of the layer 410 can vary from about 0.1 mm to about 4 mm, more particularly about 0.2 mm to about 2 mm, e.g., about 0.3 mm to about 1.5 mm. The fibers need not be present in a uniform amount across the surface of the layer 310. For example, edges of the layer 410 may include a higher or lower amount of fibers than fibers present at a central area of the layer 410. Materials other than the reinforcement fibers and the binder may also be present in the layer 410. For example, colorants, dyes, elastomers, flame retardant agents, powders, fillers, whiskers, texturizing agents, crystals, particles and the like can be present in the layer 410 as desired.

In some embodiments, the binder of the layer 410 may be an amorphous material. Where an amorphous material is present in the layer 410, the average glass transition temperature of the amorphous material can be the same as or can be higher than a melting point of the thermoplastic material present in the core layer 105. Where the average glass transition temperature of the amorphous material is the same as the melting point of the thermoplastic material, the layer 410 can “melt” into the porous layer to some degree, which can act to adhere the layer 410 to the porous layer 105. In other configurations as noted below, an adhesive layer may be present between the porous layer 105 and the reinforcement layer. In some embodiments, the amorphous material of the layer 410 may be an amorphous thermoplastic material, an amorphous polyolefin material, an amorphous polyester material, an amorphous polyethylene terephthalate material, or combinations or blends thereof. Illustrative specific amorphous binder materials that can be present in the layer 410 include, but are not limited to, amorphous polyethylene, amorphous polypropylene, amorphous polyethylene terephthalate, amorphous polystyrene, amorphous polycarbonate, amorphous polysulfone, amorphous polyetherimide, amorphous polymethyl methacrylate, amorphous acrylonitrile butadiene styrene and combinations or blends thereof. If desired, the binder can include a combination of amorphous materials and non-amorphous materials. In some examples, the binder can be a non-amorphous material such as, for example, a polyolefin, polypropylene, PET, PVC, a polyurethane, a UV curable resin, a vinyl ester, an epoxy resin or epoxy material or other non-amorphous materials.

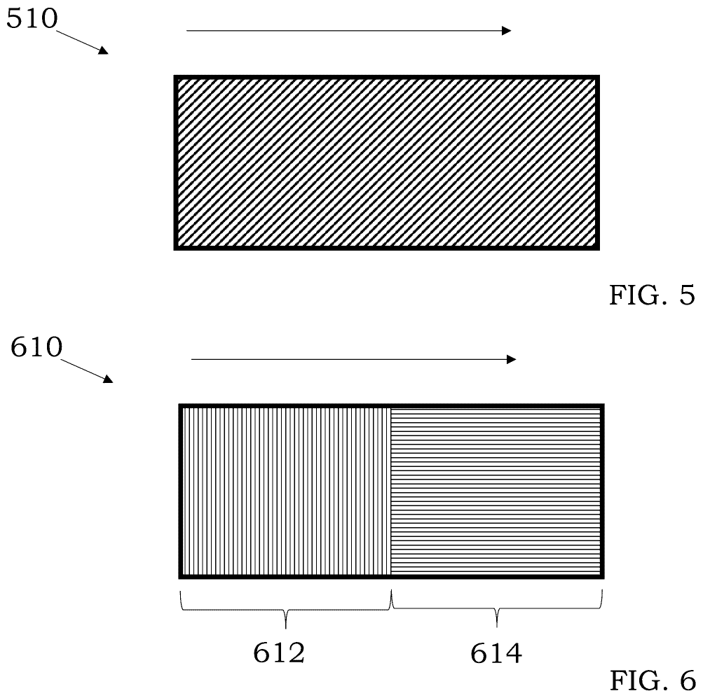

In certain embodiments, the fibers in the reinforcement layer 110 need not be arranged at only 0 degrees or 90 degrees. For example, the fibers can be arranged at any angle between these values but are not randomly arranged at multiple different angles. FIG. 5 show a 45 degree arrangement of fibers in a reinforcement layer 510. The 45 degree angle could be reversed or flipped by 90 degrees to provide a 45 degree angle orientation of fibers relative to the machine direction. The fibers could instead be present at other angles including, but not limited to, 5 degrees, 10 degrees, 15 degrees, 20 degrees, 25 degrees, 30 degrees, 35 degrees, 40 degrees, 50 degrees, 55 degrees, 60 degrees, 65 degrees, 70 degrees, 75 degrees, 80 degrees, 85 degrees or any value between these values. Where fibers are arranged at angles other than 90 degrees or 0 degrees, the basis weight and thickness of such layers can be similar to those values described in reference to layers 310 and 410.

In certain embodiments, the reinforcement layers described herein can include more than a single type of fiber. For example, glass fibers may be present in combination with non-glass fibers in the reinforcement layer. The different types of fibers may be present in an intermixed fashion with different fiber types being adjacent to each other across a surface of the layer or may be present in a segregated manner with one type of fiber being present in one area or areas of the reinforcement layer and a second type of fibers being present in other areas of the reinforcement layer.

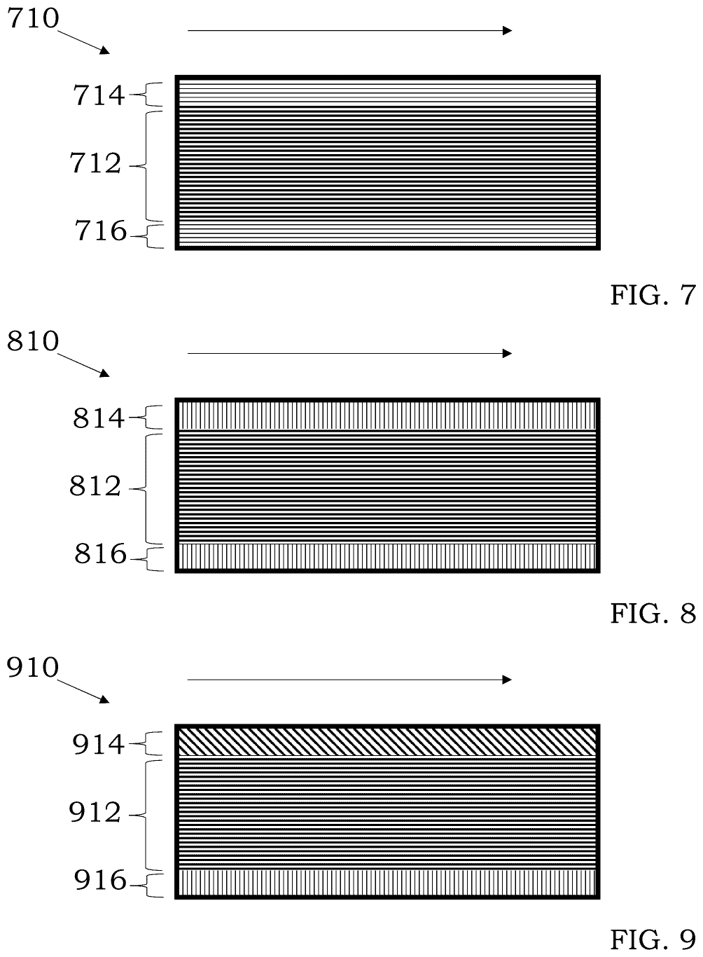

In some configurations, a single reinforcement layer may have two different fiber arrangements or different fiber densities within the same layer. An illustration is shown in FIG. 6, where a first area 612 of a reinforcement layer 610 comprises a 90 degree arrangement of fibers and a second area 614 comprises a 0 degree arrangement of fibers. Another illustration is shown in FIG. 7, where a reinforcement layer 710 comprises a central area 712 with a 0 degree fiber arrangement having a higher density than 0 degree arranged fibers at areas 714, 716. An additional arrangement is shown in FIG. 8, where a reinforcement layer 810 comprises a central area 812 with a 0 degree fiber arrangement having a higher density than 90 degree arranged fibers at areas 814, 816. The fiber arrangement need not be symmetric across a surface of the reinforcement layers. For example and referring to FIG. 9, a reinforcement layer is shown that comprises fibers at edges with different orientations. The fibers at a central area 912 have a 0 degree orientation, the fibers at an area 914 have a 45 degree orientation, and the fibers at an area 916 have a 90 degree orientation. Other configurations of different fiber arrangements in a single reinforcement layer and/or different fiber densities within a single reinforcement layer are also possible.

In certain embodiments, the reinforcement layers described herein, e.g., layers 110, 310, 410, 510, 610, 710, 810 and 910, are typically non-porous, e.g., have 0% porosity. If desired, however, certain areas of the reinforcement layers can be porous, permeable or open to air flow. In use of the reinforcement layers in composite articles, the final reinforcement layer present after production of the composite article is typically non-porous and comprises the reinforcing fibers in combination with an amorphous binder and optionally other materials. The reinforcement layer may be water or moisture resistant and/or waterproof if desired.

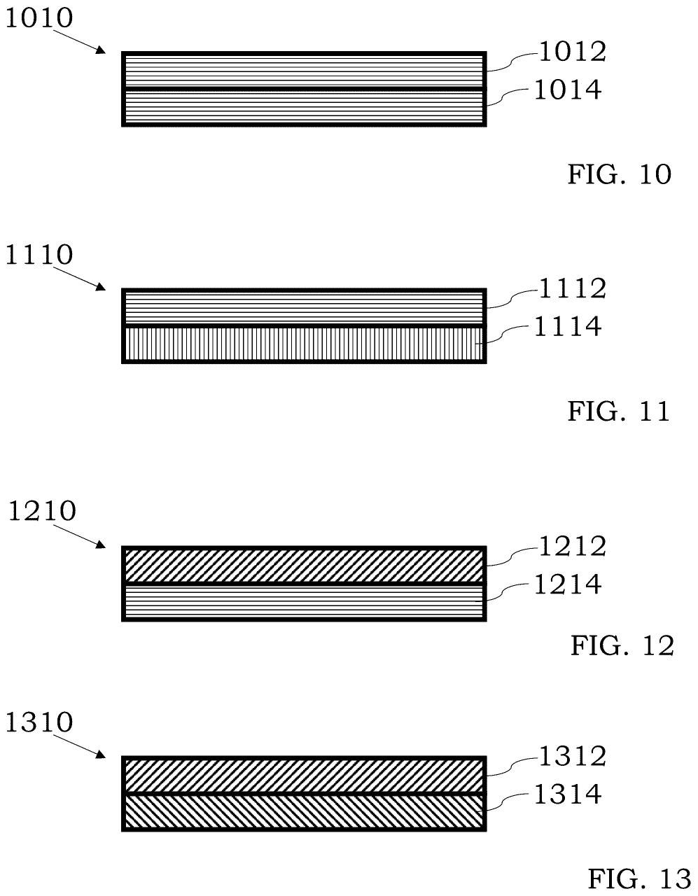

In certain embodiments, two or more reinforcement layers can be used with each other. For example, a two-ply, three-ply, four-ply or multi-ply arrangements of reinforcement layers can be present on a surface of a porous layer. Various illustrations are shown in FIGS. 10-13. The binder materials and fibers in each of the reinforcement layers need not be the same, but may be the same, when multiple reinforcement layers are used.

Referring to FIG. 10, a side view of a two-ply arrangement 1010 is shown where a first ply 1012 comprises a 0 degree arrangement of fibers and a second ply 1014 comprises a 0 degree arrangement of fibers. The fibers and binder in the layers 1012, 1014 can be different or the same. In some embodiments, the fibers and binder in each layer 1012, 1014 can be the same but the fiber density may be different in one of the layers 1012, 1014. Either of the layers 1012, 1014 can be adjacent to a core layer as desired. Another illustration of a two-ply arrangement 1110 is shown in FIG. 11 where a 0 degree fiber layer 1112 is coupled to a 90 degree fiber layer 1114. Either of the layers 1112, 1114 can be adjacent to a core layer as desired. Another illustration of a two-ply arrangement 1210 is shown in FIG. 12 where a 45 degree fiber layer 1212 is coupled to a 0 degree fiber layer 1214. Either of the layers 1212, 1214 can be adjacent to a core layer as desired. Another illustration of a two-ply arrangement 1210 is shown in FIG. 13 where a 45 degree fiber layer 1312 is coupled to a 45 degree fiber layer 1314. Either of the layers 1312, 1314 can be adjacent to a core layer as desired. While the fibers are arranged 45 degrees relative to the machine direction in FIG. 13, the fibers in the layer 1312 are arranged at a positive 45 degree angle and the fibers in the layer 1314 are arranged at a negative 45 degree angle. Additional fiber angles in two-ply arrangements are also possible. Two of the two-ply arrangements can be stacked to provide a four-ply arrangement. Three of the two-ply arrangements can be stacked to provide a six-ply arrangement. Four of the two-ply arrangements can be stacked to provide a n eight-ply arrangement.

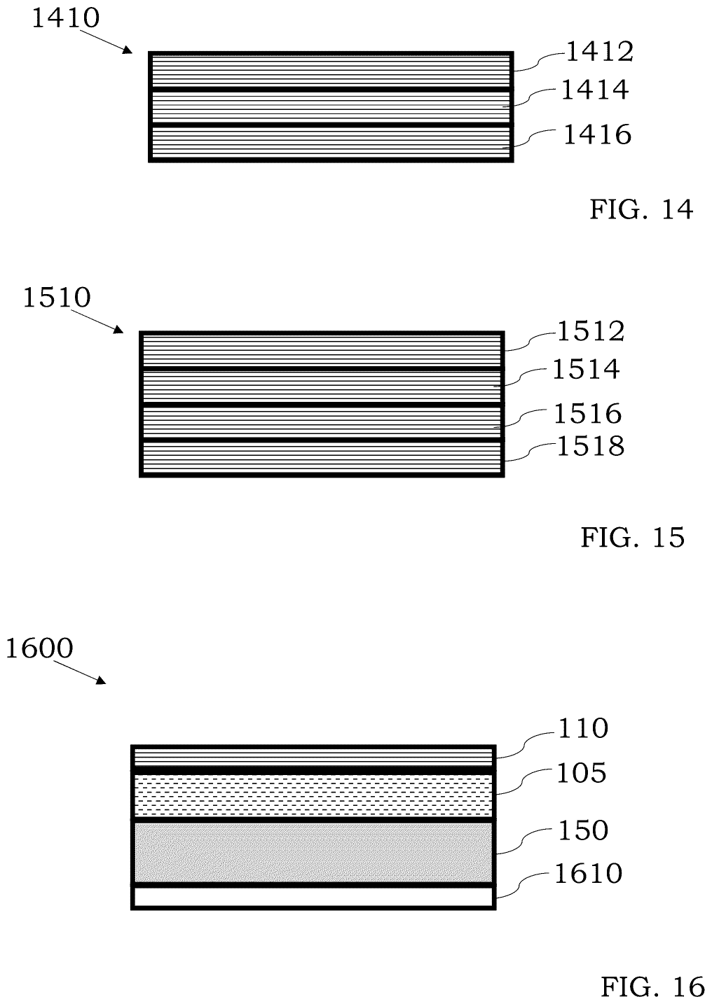

In certain embodiments, three ply arrangements of reinforcing layers may be used in the composite articles described herein. Referring to FIG. 14, an illustration is shown where a three ply arrangement 1410 comprises reinforcement layers 1412, 1414, and 1416. Each of the reinforcement layers 1412, 1414, 1416 may comprise the same or a different arrangement of fibers and may comprise the same or different binder material. In one example, the angle of the fibers in the layers 1412/1414/1416 is 0/0/0, respectively. In another example, the angle of the fibers in the layers 1412/1414/1416 is 0/90/0, respectively. In another example, the angle of the fibers in the layers 1412/1414/1416 is 0/90/90, respectively. In another example, the angle of the fibers in the layers 1412/1414/1416 is 0/0/90, respectively. In another example, the angle of the fibers in the layers 1412/1414/1416 is 90/0/90, respectively. In another example, the angle of the fibers in the layers 1412/1414/1416 is 90/0/0, respectively. In another example, the angle of the fibers in the layers 1412/1414/1416 is 0/0/90, respectively. In another example, the angle of the fibers in the layers 1412/1414/1416 is 0/90/0, respectively.

In some examples, the layer 1412 comprises a 0 degree angle of fibers, and the angle of the fibers in the layers 1414, 1416 are each independently between 0 degrees and 90 degrees. In other examples, the layer 1412 comprises a 90 degree angle of fibers, and the angle of the fibers in the layers 1414, 1416 are each independently between 0 degrees and 90 degrees. In some examples, the layer 1412 comprises a non-zero degree angle of fibers (greater than 0 and up to 90), and the angle of the fibers in the layers 1414, 1416 are each independently between 0 degrees and 90 degrees. In some examples, the layer 1414 comprises a 0 degree angle of fibers, and the angle in the fibers in the layers 1412, 1416 are each independently between 0 degrees and 90 degrees. In other examples, the layer 1414 comprises a 90 degree angle of fibers, and the angle in the fibers in the layers 1412, 1416 are each independently between 0 degrees and 90 degrees. In some examples, the layer 1412 comprises a non-zero degree angle of fibers (greater than 0 and up to 90), and the angle in the fibers in the layers 1412, 1416 are each independently between 0 degrees and 90 degrees. In some examples, the layer 1416 comprises a 0 degree angle of fibers, and the angle in the fibers in the layers 1412, 1414 are each independently between 0 degrees and 90 degrees. In other examples, the layer 1416 comprises a 90 degree angle of fibers, and the angle in the fibers in the layers 1412, 1414 are each independently between 0 degrees and 90 degrees. In some examples, the layer 1416 comprises a non-zero degree angle of fibers (greater than 0 and up to 90), and the angle in the fibers in the layers 1412, 1414 are each independently between 0 degrees and 90 degrees. In certain embodiments, each of the layers 1412, 1414, and 1416 independently comprises any fiber arrangement between 0 degrees and 90 degrees. If desired, one or two of the layers 1412, 1414 and 1416 may comprise a random arrangement of fibers. In use of the three ply arrangement 1410, either layer 1412 or layer 1416 can be placed adjacent to a porous layer. The amorphous binder of the various layers 1412, 1414 and 1416 can be the same or can be different. In some examples, an amount of amorphous binder in one of the layers 1412, 1414, 1416 can be different than an amount of amorphous binder in another one of the layers 1412, 1414, 1416.

In certain configurations, four ply arrangements of reinforcing layers may be used in the composite articles described herein. Referring to FIG. 15, an illustration is shown where a three ply arrangement 1510 comprises reinforcement layers 1512, 1514, 1516 and 1518. In some embodiments, the layer 1512 comprises a fiber arrangement of 0 degrees, and each of the layers 1514, 1516 and 1518 comprises a fiber arrangement of 0 degrees to 90 degrees. In other embodiments, the layer 1512 comprises a fiber arrangement of 90 degrees, and each of the layers 1514, 1516 and 1518 comprises a fiber arrangement of 0 degrees to 90 degrees. In some embodiments, the layer 1514 comprises a fiber arrangement of 0 degrees, and each of the layers 1512, 1516 and 1518 comprises a fiber arrangement of 0 degrees to 90 degrees. In other embodiments, the layer 1514 comprises a fiber arrangement of 90 degrees, and each of the layers 1512, 1516 and 1518 comprises a fiber arrangement of 0 degrees to 90 degrees. In some embodiments, the layer 1516 comprises a fiber arrangement of 0 degrees, and each of the layers 1512, 1514 and 1518 comprises a fiber arrangement of 0 degrees to 90 degrees. In other embodiments, the layer 1516 comprises a fiber arrangement of 90 degrees, and each of the layers 1512, 1514 and 1518 comprises a fiber arrangement of 0 degrees to 90 degrees. In some embodiments, the layer 1518 comprises a fiber arrangement of 0 degrees, and each of the layers 1512, 1514 and 1516 comprises a fiber arrangement of 0 degrees to 90 degrees. In other embodiments, the layer 1518 comprises a fiber arrangement of 90 degrees, and each of the layers 1512, 1514 and 1516 comprises a fiber arrangement of 0 degrees to 90 degrees.

In some embodiments, a fiber angle of 0 degrees is present in at least two of the layers 1512, 1514, 1516 and 1518. In other embodiments, a fiber angle of 90 degrees is present in at least two of the layers 1512, 1514, 1516 and 1518. In some embodiments, a fiber angle of greater than 0 degrees and less than 90 degrees is present in at least two of the layers 1512, 1514, 1516 and 1518. In other embodiments, a fiber angle of 0 degrees is present in at least three of the layers 1512, 1514, 1516 and 1518. In some embodiments, a fiber angle of 90 degrees is present in at least three of the layers 1512, 1514, 1516 and 1518. In other embodiments, a fiber angle of greater than 0 degrees and less than 90 degrees is present in at least three of the layers 1512, 1514, 1516 and 1518. In some examples, the layers 1512 and 1518 may comprise a 0 degree fiber angle and the layers 1514, 1516 may comprise any fiber angle from 0 degrees up to 90 degrees. In other examples, the layers 1512 and 1518 may comprise a 90 degree fiber angle and the layers 1514, 1516 may comprise any fiber angle from 0 degrees up to 90 degrees.

In other examples, the layers 1512 and 1518 may comprise an angle greater than 0 and up to 90 degrees and the layers 1514, 1516 may comprise any fiber angle from 0 degrees up to 90 degrees. In some examples, the layers 1514 and 1516 may comprise a 0 degree fiber angle and the layers 1512, 1518 may comprise any fiber angle from 0 degrees up to 90 degrees. In other examples, the layers 1514 and 1516 may comprise a 90 degree fiber angle and the layers 1512, 1518 may comprise any fiber angle from 0 degrees up to 90 degrees. In other examples, the layers 1514 and 1516 may comprise an angle greater than 0 and up to 90 degrees and the layers 1512, 1518 may comprise any fiber angle from 0 degrees up to 90 degrees. Specific fiber arrangements of the layers 1512/1514/1516/1518 include for example: 0/0/0/0, 0/90/0/0, 0/90/90/0, 0/90/90/90, 90/0/0/0, 90/90/0/0, 90/90/90/0, 90/0/0/90, 90/90/90/90, 0/0/90/0, 0/0/90/90. 90/0/90/90, 90/90/0/90, and 0/x/y/z, 90/x/y/z where x, y and z are independently any angle between 0-90 degrees. In use of the four ply arrangement 1510, either layer 1512 or layer 1518 can be placed adjacent to a porous layer. The amorphous binder of the various layers 1512, 1514, 1516 and 1518 can be the same or can be different. In some examples, an amount of amorphous binder in one or more of the layers 1512, 1514, 1516 and 1518 can be different than an amount of amorphous binder in another one of the layers 1512, 1514, 1516 and 1518.

In certain embodiments, five ply, six ply, seven ply, eight ply or more can be used in the composite articles described herein. In some configurations, a basis weight of each ply may vary depending on the number of plys present in the composite article. In some embodiments, each reinforcement layer may comprise a basis weight between 100 g/m² to 800 g/m². As more plys are present, the basis weight of each reinforcement layer generally decreases to reduce the overall weight of the composite article. Each layer in a multi-ply arrangement can include any of those fibers and amorphous binders described in reference to the layers 110, 310 and 410. The total weight of a multi-ply arrangement may vary, for example, from 200 gsm to about 4000 gsm, more particularly about 400 gsm to about 3000 gsm or about 800 gsm to about 2400 gsm. The fibers in each layer of a multi-ply arrangement can independently be organic reinforcing fibers, inorganic reinforcing fibers, glass fibers, carbon fibers, aramid fibers, metal fibers and combinations or blends thereof. The binder can be any one or more of the amorphous binders as described in reference to the layers 110, 310 and 410 or may include a combination of amorphous and non-amorphous materials or even just non-amorphous materials if desired. The fibers need not be present in a uniform amount across the surface of each layer in the ply. Materials other than the reinforcement fibers and the binder may also be present in each layer of the multiply arrangement. For example, colorants, dyes, elastomers, flame retardant agents, powders, fillers, whiskers, texturizing agents, crystals, particles and the like can be present in each layer as desired. In a typical arrangement, the binder material in each the layer of a multiply arrangement has an average glass transition temperature that is either the same as or is higher than a melting point of the thermoplastic material present in the porous layer 105. Illustrative binder materials that can be present in each layer of a multiply arrangement include, but are not limited to, amorphous polyethylene, amorphous polypropylene, amorphous polyethylene terephthalate, amorphous polystyrene, amorphous polycarbonate, amorphous polysulfone, amorphous polyetherimide, amorphous polymethyl methacrylate, amorphous acrylonitrile butadiene styrene and combinations or blends thereof.

In certain embodiments, the thermoplastic composite article can include an additional layer on a second surface of the core layer. Referring to FIG. 16, an article 1600 is shown that comprises an additional layer or skin layer 1610 on a second surface of the layer 150 opposite where the reinforcement layer 110 and the porous layer 105 are present. The additional layer 1610 can include many different materials and may adopt many different configurations. In some examples, the layer 1610 may act as a support structure or support layer. The layer 1610 can be joined to the core layer 150 through an adhesive layer or can be joined to the core layer 150 without any adhesive layer. In certain embodiments, the additional layer 1610 may comprise, for example, a film (e.g., thermoplastic film or elastomeric film), a frim, a scrim (e.g., fiber based scrim), a foil, a woven fabric, a non-woven fabric or be present as an inorganic coating, an organic coating, or a thermoset coating disposed on the core layer 105. In some examples, the layer 1610 may comprise natural fibers, polymeric fibers, or other materials. In other instances, the layer 1610 may comprise a limiting oxygen index greater than about 22, as measured per ISO 4589 dated 1996. Where a thermoplastic film is present as (or as part of) the layer 1610, the thermoplastic film may comprise at least one of poly(ether imide), poly(ether ketone), poly(ether-ether ketone), poly(phenylene sulfide), poly(arylene sulfone), poly(ether sulfone), poly(amide-imide), poly(1,4-phenylene), polycarbonate, nylon, and silicone. Where a fiber based scrim is present as (or as part of) the layer 1610, the fiber based scrim may comprise at least one of glass fibers, aramid fibers, graphite fibers, carbon fibers, inorganic mineral fibers, metal fibers, metalized synthetic fibers, and metalized inorganic fibers. Where a thermoset coating is present as (or as part of) the layer 1610, the coating may comprise at least one of unsaturated polyurethanes, vinyl esters, phenolics and epoxies. Where an inorganic coating is present as (or as part of) the layer 1610, the inorganic coating may comprise minerals containing cations selected from Ca, Mg, Ba, Si, Zn, Ti and Al or may comprise at least one of gypsum, calcium carbonate and mortar. Where a non-woven fabric is present as (or as part of) the layer 1610, the non-woven fabric may comprise a thermoplastic material, a thermal setting binder, inorganic fibers, metal fibers, metallized inorganic fibers and metallized synthetic fibers. If desired, the additional layer 1610 may comprise one or more reinforcement layers as described herein. For example, a reinforcement layer with an arrangement of fibers can also be present as the layer 1610. The reinforcement layer may be present as a single ply or as a multiply arrangement as desired. In other embodiments, a porous layer similar to porous layer 105 can be present as the layer 1610.

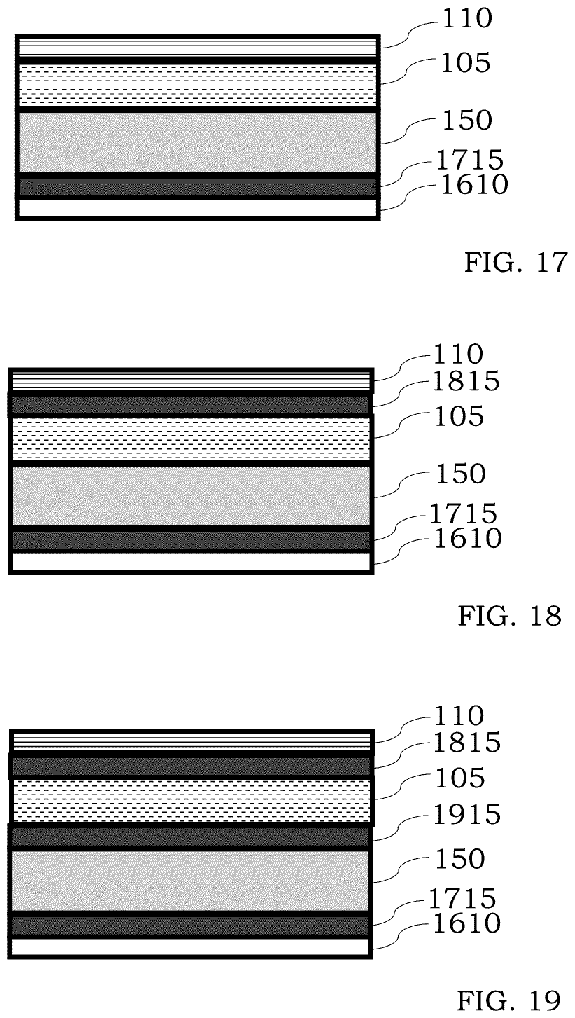

In some embodiments, any one or more of the layers described herein can be coupled to each other through an adhesive layer. For example, the layer 1610 may be coupled to the core layer 150 through an adhesive layer 1715 as shown in FIG. 17. The adhesive layer 1715 can include thermoplastic materials and/or thermosetting materials as desired. For example, one or more thermoplastic polymer adhesives may be used. In some examples, the thermoplastic component of the adhesive layer may comprise a thermoplastic polymer such as, for example, a polyolefin such as a polyethylene or a polypropylene. In other instances, the thermoplastic polymer of the adhesive layer may comprise, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastic polymers for use in the adhesive layer include, but are not limited to, polyarylene ethers, polycarbonates, polyestercarbonates, thermoplastic polyesters, polyimides, polyetherimides, polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as alloys and blends of these materials with each other or other polymeric materials. If desired, the adhesive may also comprise some thermosetting material including, but not limited to, epoxides, epoxy resins, polyesters, polyester resins, urethanes, polyurethanes, diallyl-phthalates, polyamides, cyanate esters, polycyanurates and combinations or blends thereof.

In some configurations, the fiber reinforcement layer 110 can be coupled to the porous layer 105 through an adhesive or tie layer as shown in FIG. 18. The adhesive layer 1815 can include thermoplastic materials and/or thermosetting materials as desired. For example, one or more thermoplastic polymer adhesives may be used. In some examples, the thermoplastic component of the adhesive layer may comprise a thermoplastic polymer such as, for example, a polyolefin such as a polyethylene or a polypropylene. In other instances, the thermoplastic polymer of the adhesive layer may comprise, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastic polymers for use in the adhesive layer include, but are not limited to, polyarylene ethers, polycarbonates, polyestercarbonates, thermoplastic polyesters, polyimides, polyetherimides, polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as alloys and blends of these materials with each other or other polymeric materials. If desired, the adhesive may also comprise some thermosetting material including, but not limited to, epoxides, epoxy resins, polyesters, polyester resins, urethanes, polyurethanes, diallyl-phthalates, polyamides, cyanate esters, polycyanurates and combinations or blends thereof. The adhesive layer 1815 is optional and may be omitted when the fiber reinforcement layer 110 bonds to the porous layer 105 in a sufficient manner.

In another configuration, an adhesive layer can be present between the porous layer 105 and the core layer 150. Referring to FIG. 19, an adhesive layer 1915 can include thermoplastic materials and/or thermosetting materials as desired. For example, one or more thermoplastic polymer adhesives may be used. In some examples, the thermoplastic component of the adhesive layer may comprise a thermoplastic polymer such as, for example, a polyolefin such as a polyethylene or a polypropylene. In other instances, the thermoplastic polymer of the adhesive layer may comprise, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastic polymers for use in the adhesive layer include, but are not limited to, polyarylene ethers, polycarbonates, polyestercarbonates, thermoplastic polyesters, polyimides, polyetherimides, polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as alloys and blends of these materials with each other or other polymeric materials. If desired, the adhesive may also comprise some thermosetting material including, but not limited to, epoxides, epoxy resins, polyesters, polyester resins, urethanes, polyurethanes, diallyl-phthalates, polyamides, cyanate esters, polycyanurates and combinations or blends thereof. The adhesive layer 1915 is optional and may be omitted when the core layer 150 bonds to the porous layer 105 in a sufficient manner.

In use of the composite articles shown in FIGS. 17-19, the fiber reinforcement layer 110 typically is exposed or is positioned suitably to absorb impacts in the use environment of the composite article. For example, when the article is configured as flooring or a flooring panel, the reinforcement layer 110 can face toward an interior surface of a room or vehicle rather than toward a support structure in the room or vehicle. The fiber reinforcement layer 110 can provide impact resistance such that stepping on, or impacting, the composite article does not result in delamination or destruction of the flooring or flooring panel. Impact resistance can vary depending on the particular end use of the composite article. Where the composite article is configured as flooring or a flooring panel, impact resistance can be measured by ASTM D1037-12 and can be 230 N or more, e.g., 250, 260, 270, 280, 290 or 300 N or more. For example, a flooring panel as described herein with an overall thickness from 5 mm to 7 mm can have about the same impact resistance as about 10 mm thick plywood flooring. In addition to improved impact resistance at a lower thickness, the flooring and flooring panels described herein can also be resistant to rot, moisture, mold and mildew.

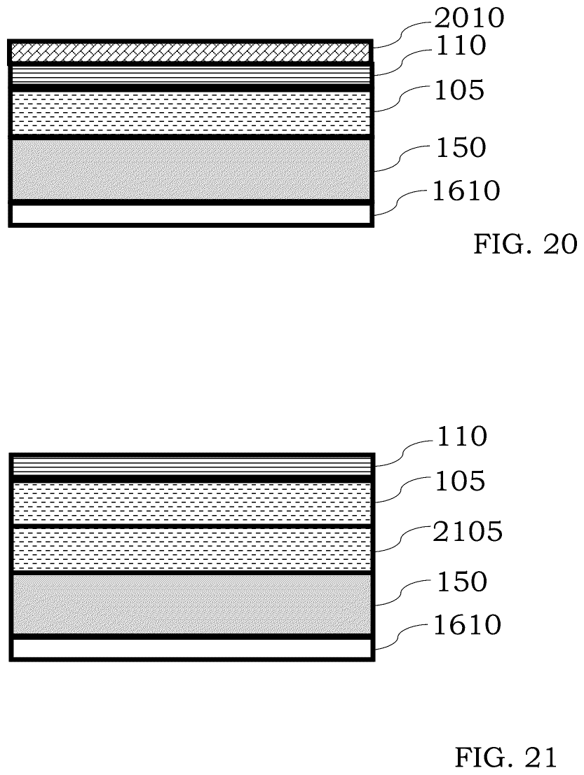

In certain configurations, a composite article can include a decorative layer on one or more surfaces. For example and referring to FIG. 20, fiber reinforced thermoplastic composite can include a decorative layer 2010 on the fiber reinforcement layer 110. In certain embodiments, the decorative layer 2010 may be formed, e.g., from a thermoplastic film of polyvinyl chloride, polyolefins, thermoplastic polyesters, thermoplastic elastomers, paper, or the like. The decorative layer 2010 may also be a multi-layered structure if desired. For example, a fabric may be bonded to a foam core (or other structures), such as woven fabrics made from natural and synthetic fibers, organic fiber non-woven fabric after needle punching or the like, raised fabric, knitted goods, flocked fabric, or other such materials. The fabric may also be bonded with a thermoplastic adhesive, including pressure sensitive adhesives and hot melt adhesives, such as polyamides, modified polyolefins, urethanes and polyolefins. The decorative layer 2010 may also be produced using spunbond, thermal bonded, spun lace, melt-blown, wet-laid, and/or dry-laid processes. In some embodiments, the decorative layer 2010 may be embossed, textured or otherwise include some pattern or grain structure.

In some embodiments, an adhesive layer (not shown) may optionally be present between the decorative layer 2010 and the layer 110. In instances where an adhesive is desirable, one or more thermoplastic polymer adhesives may be used. For example, it may be desirable to couple the decorative layer 2010 to the layer 110 using an adhesive. In some examples, the thermoplastic component of the adhesive layer may comprise a thermoplastic polymer such as, for example, a polyolefin such as a polyethylene or a polypropylene. In other instances, the thermoplastic polymer of the adhesive layer may comprise, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastic polymers for use in the adhesive layer include, but are not limited to, polyarylene ethers, polycarbonates, polyestercarbonates, thermoplastic polyesters, polyimides, polyetherimides, polyamides, acrylonitrile- butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as alloys and blends of these materials with each other or other polymeric materials. If desired, the adhesive may also comprise some thermosetting material including, but not limited to, epoxides, epoxy resins, polyesters, polyester resins, urethanes, polyurethanes, diallyl-phthalates, polyamides, cyanate esters, polycyanurates and combinations or blends thereof.

In certain embodiments, the articles described herein can include two or more porous layers. Referring to FIG. 21, an article comprises a first porous layer 105 and a second porous layer 2105. The reinforcement layer 110 can be coupled to the first porous layer 105 through an adhesive layer (not shown). The first porous layer 105 and the second porous layer 2105 can be the same or can be different. In some embodiments, the first porous layer 105 and the second porous layer 2105 may comprise the same materials but may have a different thickness or basis weight. In other configurations, the first porous layer 105 and the second porous layer 2105 may comprise different thermoplastic materials. In additional configurations, the first porous layer 105 and the second porous layer 2105 may comprise different reinforcing fibers. If desired, more than two porous layers can be present in a composite article. In some embodiments, the two porous layers 105, 2105 can be separated by a layer such as, for example, a film, a scrim, a reinforcement layer, an adhesive layer or other layers. In some configurations, the reinforcement layer 110 in FIG. 21 may be a two ply, three ply, four ply, five ply, six ply or have more than six plys as desired. The core layer 150 in FIG. 21 can be porous or non-porous. The layer 1610 in FIG. 21 can be a support layer, a skin layer, a porous layer or another reinforcement layer as desired. An adhesive layer may be present between any two or more layers in FIG. 21 or may be present between each layer shown in FIG. 21.

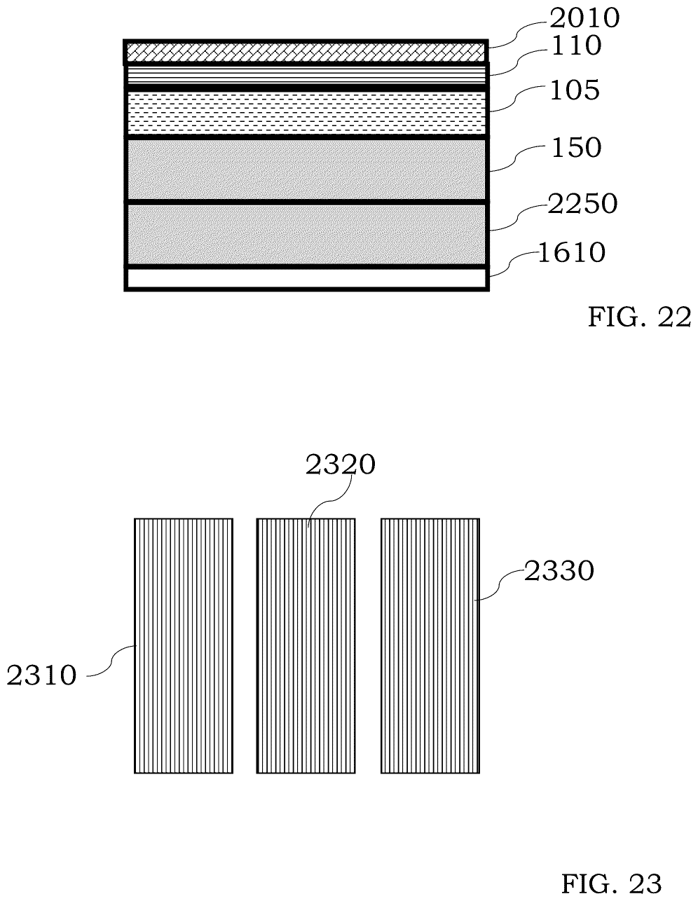

In certain embodiments, the articles described herein can include two or more core layers. Referring to FIG. 22, an article comprises a first core layer 150 and a second core layer 2250. The reinforcement layer 110 can be coupled to the porous layer 105 through an adhesive layer (not shown). The first core layer 150 and the second core layer 2250 can be the same or can be different. In some embodiments, the first core layer 150 and the second core layer 2250 may comprise the same materials but may have a different thickness or basis weight. In other configurations, the first core layer 150 and the second core layer 2250 may comprise different thermoplastic materials. In additional configurations, the first core layer 105 and the second core layer 2250 may comprise different types of foams. If desired, more than two core layers can be present in a composite article. In some embodiments, the two core layers 150, 2250 can be separated by a layer such as, for example, a film, a scrim, a reinforcement layer, an adhesive layer or other layers. In some configurations, the reinforcement layer 110 in FIG. 22 may be a two ply, three ply, four ply, five ply, six ply or have more than six plys as desired. The layer 1610 in FIG. 22 can be a support layer, a skin layer, a porous layer or another reinforcement layer as desired. An adhesive layer may be present between any two or more layers in FIG. 22 or may be present between each layer shown in FIG. 22.

In certain embodiments, any one or more of the porous layers described herein may be configured as (or used in) a glass mat thermoplastic composite (GMT) or a light weight reinforced thermoplastic (LWRT). The areal density of such a GMT or LWRT can range from about 200 grams per square meter (gsm) of the GMT or LWRT to about 4000 gsm, although the areal density may be less than 200 gsm or greater than 4000 gsm depending on the specific application needs. In some embodiments, the upper density can be less than 4000 gsm.

In certain examples, one or more of the porous layers described herein can be generally prepared using chopped fibers (reinforcing fibers), a thermoplastic material, optionally a lofting agent and/or other materials. For example, a thermoplastic material and any fibers can be added or metered into a dispersing foam contained in an open top mixing tank fitted with an impeller. Without wishing to be bound by any particular theory, the presence of trapped pockets of air of the foam can assist in dispersing the fibers and the thermoplastic material. In some examples, the dispersed mixture of fibers and thermoplastic material can be pumped to a head-box located above a wire section of a paper machine via a distribution manifold. The foam, not the fibers and thermoplastic, can then be removed as the dispersed mixture is provided to a moving wire screen using a vacuum, continuously producing a uniform, fibrous wet web comprising the fibers and the thermoplastic material. The wet web can be passed through a dryer at a suitable temperature to reduce moisture content and to melt or soften the thermoplastic material. The reinforcement layers, additional layers, decorative layers, etc. can then be applied to the web optionally using an adhesive material between the web and the other layers. The assembly can be passed through one or more sets of rollers to pressure the skins into the web and/or compress the assembly to a desired thickness. The resulting thermoplastic composite article can be cut, sized or otherwise subjected to post-production steps as desired. The machine direction of the process generally refers to the direction of the moving wire screen, whereas the cross direction refers to a direction orthogonal to the machine direction.

In certain configurations, the fiber reinforcement layers described herein can be produced by adding a binder to an arrangement of fibers. In a typical production method, each layer or ply is produced and then bonded together with other plys to provide a multiply arrangement. The resulting multiply product can be rolled, made in sheets, diced, cut, or otherwise processed to provide a desired dimensional size and shape.

In certain embodiments, the core layers, porous layers, fiber reinforcement layers, skin layers and/or the thermoplastic composite articles described herein can be used to produce interior components or parts for vehicles, building applications and other applications. For example, the thermoplastic composite article may be present in a vehicular panel, an interior automotive part, a vehicle load floor, flooring, a flooring panel, a recreational vehicle panel or a recreational vehicle part, a bunk of a vehicle, a cab-over, a shelf or as other articles.

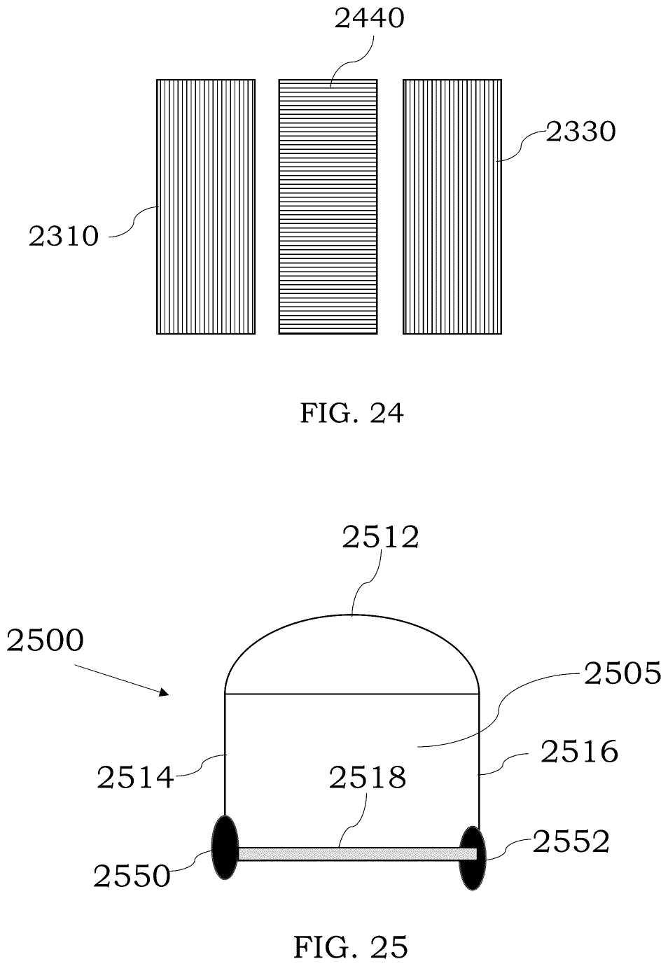

In certain embodiments, the articles described herein can be used as flooring or floor panels. Referring to FIG. 23, three panels 2310, 2320, 2330 are shown as being positioned adjacent to each other. Each panel 2310, 2320, 2330 may include any one or more of the various layers described herein. For example, panel 2310 may include a multiply fiber reinforcement assembly in combination with a porous layer, a core layer and optionally a support layer. Each of the panels 2310, 2320, 2330 can be the same or can be different. For example and referring to FIG. 24, a panel 2440 with a 90-degree fiber orientation on an outer surface can be positioned between panels 2310, 2330. In use, the panels can be abutted against each other and a top layer or covering may be added to form a final vehicle floor. For example, a carpet, plastic or other covering layer may be placed on top of the panels 2310, 2320 (or 2440), 2330 when they are positioned against each other. The exact number of panels used in any vehicle floor may vary from 2 to about 20 or more than 20. Each of the panels 2310, 2320 (or 2440), 2330 may independently include a fiber reinforcement layer assembly comprising two, three, four, five or six (or more) individual layers or plys, wherein at least one layer of the tape comprises an arrangement of fibers and an amorphous material. As noted herein, an outer layer, e.g., film, scrim, decorative layer, etc. can be present on one or more surfaces of the fiber reinforcement layer.

In certain configurations, the flooring and floor panels described herein may be present in a vehicle including, for example, a recreational vehicle, a van, a motorhome, a bus, a truck or other vehicles. For illustration purposes, a recreational vehicle 2500 is shown in FIG. 25 that includes a flooring panel as described herein. The RV 2500 includes a roof 2512, side walls 2514, 2516 coupled to the roof 2512, and a floor 2518 coupled to the sidewalls 2514, 2516 to provide an interior space 2505 within the recreational vehicle 2500. In certain configurations, the floor may include a flooring panel comprising a multiply reinforcement layer as described herein. For example, a roll of a four-ply tape (or tape with more than 4 plys) can be unrolled to the desired length. A porous layer can be coated on each side with a desired adhesive, e.g., a polyolefin adhesive or a polyurethane adhesive. One side of the porous layer can be bonded to the multiply tape. This process can be repeated with multiple porous layers sheets until the desired floor length is achieved. The tape layers may be offset from the porous layer to permit stacking of porous layers adjacent to each other. A core layer (foam and/or framing) is laid onto the back side of the glued porous layer. A bottom/support layer, which can be a porous layer or another layer, is coated with adhesive on one side and then placed onto the core layer. The entire assembly is then pressed together with a nip roller or can be laminated using heat and/or pressure.

The flooring panel can also include a porous thermoplastic layer coupled to a first surface of the multiply reinforcement layer. A core layer can be coupled to the porous layer. In some instances, the floor 2518 can include two, three or more floor panels as described herein. While not shown, the floor 2518 typically includes a covering layer, e.g., a fabric, tile, polymer, etc. over the floor panels. As noted herein, the flooring panels can include a fiber reinforcement layer assembly comprising two, three, four, five, six or more plys each of which can include a selected fiber angle arrangement.

The exact process used to produce the floors shown in FIGS. 23-25 may vary. For example, each panel could be laminated independently and then assembled together to create a larger floor. Alternatively, a process that produces a single floor laminated at one time with the seams of the individual layers overlapping could also be used. For example, the overlapping layers might be present in a selected pattern, e.g., a tile pattern, brick pattern, marble pattern etc.

In certain embodiments, the floor panels, or components thereof, may be packaged in the form of a kit that can include one or more components of the floor panel in combination with written or electronic instructions for coupling the reinforced thermoplastic layer to a tape layer. The kit can include a core layer, a porous layer, and a fiber reinforcement layer to provide the floor. In some embodiments, the kit can include a reinforced thermoplastic porous layer comprising a web of open cell structures formed by reinforcing materials held in place by a thermoplastic material. In other embodiments, the kit can include the individual fiber reinforcement layers or a fiber reinforcement layer assembly. In some examples, the kit comprises a material to produce a core layer, e.g., a foam or materials to produce a foam. For example, the kit may include materials to produce a foam layer, including one or more of an expanded foam material, an extruded foam or a cast foam. If desired, the kit can also include the support layer, e.g., a metal layer or a reinforced thermoplastic layer. For example, the support layer can include a second porous layer comprising a web of open cell structures formed by reinforcing materials held in place by a thermoplastic material.

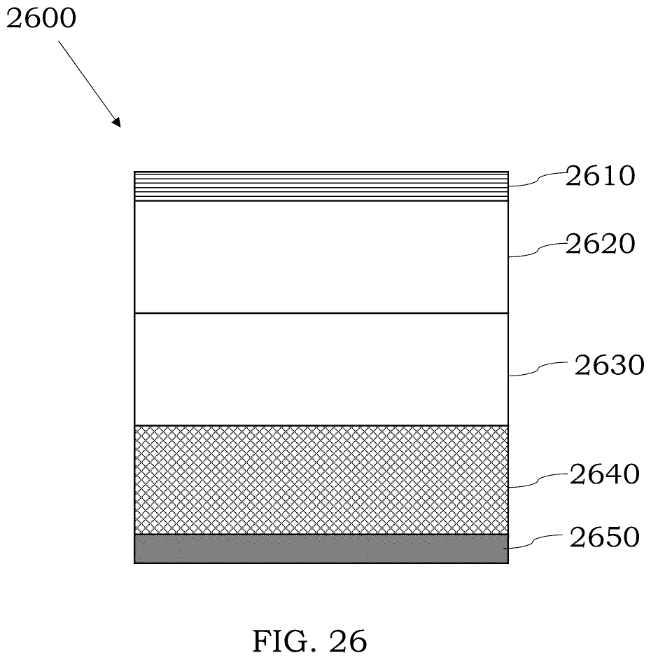

It will be recognized by the person of ordinary skill in the art, given the benefit of this disclosure, that the exact form of the various layers and/or materials described herein can vary. For example and referring to FIG. 26, the layer 2610 could include one or more of a 2-ply bi-directional glass tape (e.g., from a roll of tape), a 4-ply bi-directional glass tape (e.g., in sheet form or on a roll), a 6-ply bi-directional glass tape (e.g., in sheet form) or other multi-ply tapes in sheet form or roll form. In addition to the glass fibers in each tape, an amorphous binder may be present, e.g., an amorphous polyolefin or amorphous polyethylene terephthalate. Each of the layers 2620, 2630 can have a thickness which can vary from about 0.1 mm to about 4 mm and may be produced from a single layer or include more than one layer. For example, each of the layers 2620, 2630 can be a porous LWRT layer as described herein and may be the same or may be different. The layer 2640 can be produced using foam materials, non-foam materials or both. In some embodiments, the layer 2640 can be one or more of 1 lb/ft3 expandable polystyrene (EPS) foam, 1.5 lbs/ft3 EPS, 2 lbs/ft3 EPS, 3 lbs/ft3 EPS, 4 lbs/ft3 polyurethane foam or 6 lbs/ft3 polyurethane foam. In certain configurations, the layer 2650 can be one or more of a single fiber reinforced thermoplastic layer (e.g., with a thickness of 2 mm to about 6 mm), two single fiber reinforced thermoplastic layers (e.g., with an overall thickness of 2 mm to about 6 mm), a glass layer (e.g., a 2-ply glass layer, a 4-ply glass layer), a metal layer, a flame retardant layer, a skin layer or combinations thereof. Additional materials for the layers 2610, 2620, 2630, 2640 and 2650 can be selected by the person having ordinary skill in the art, given the benefit of this disclosure. For example, a skin layer, e.g., a film, scrim, decorative layer, etc., can be present on the layer 2650 if desired.

In certain configurations, the fiber reinforcement layer 2610 can have a basis weight of 200 gsm to 1200 gsm. In some configurations, the porous layers 2620, 2630 can each have a basis weight of 600 gsm to 2400 gsm. If desired, only a single porous layer may be present. The core layer 2640 can have a basis weight of 1 pound/ft³ to 15 pounds/ft³. The skin layer 2650 can have a basis weight of 20 gsm to 1500 gsm. The entire composite article 2600 can have a basis weight of 600 gsm to 4000 gsm.

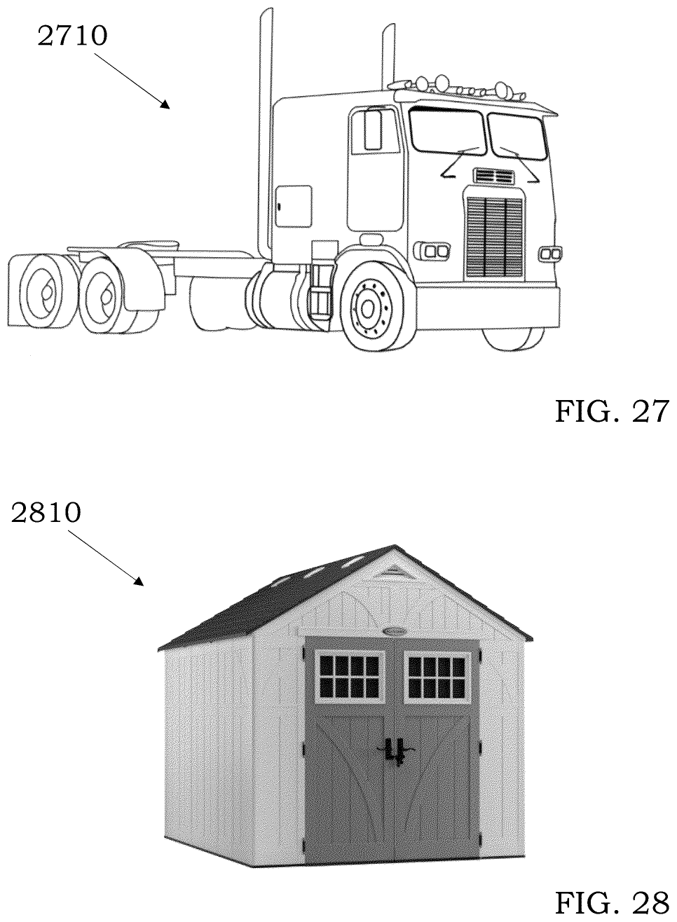

In certain embodiments, the thermoplastic composite articles described herein can be used in a cabover truck. For example and referring to FIG. 27, the floor of a cabover truck 2710, backwall of the cabover truck 2710, a sleeping area or bunk of the cabover truck 2710 or other areas of the cab over 2710 may comprise one or more of composite articles described herein.

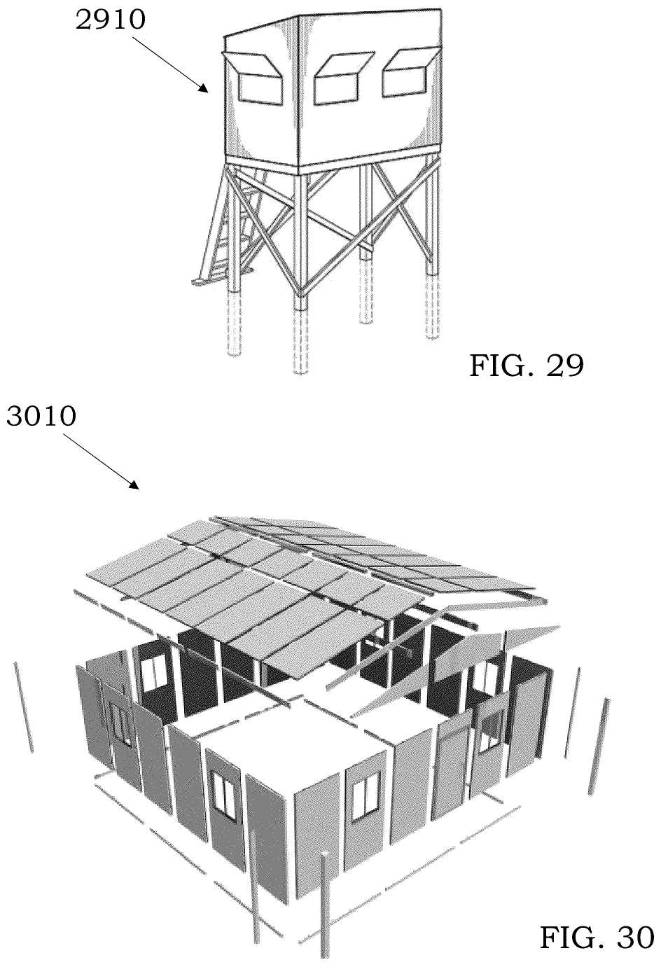

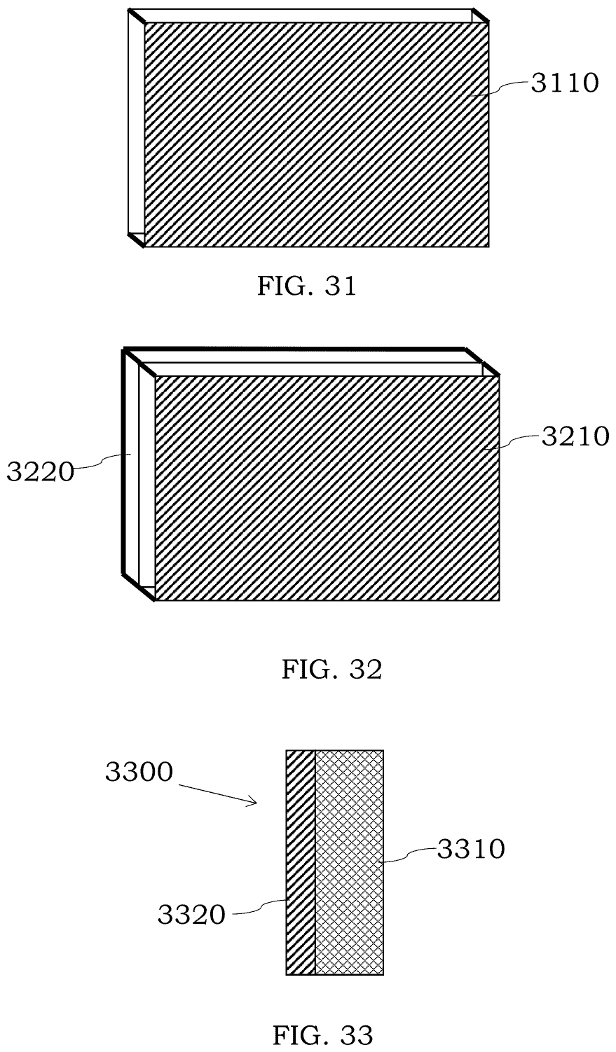

In other embodiments, the thermoplastic composite articles described herein can be used in RV bunks, bunk beds, a furniture panels, drawer panels, back panels, shelving and the like. In some embodiments, the composite article can be used in portable structures including a shed 2810 (FIG. 28), a wall, roof, flooring, ceiling or other areas of a hunting blind 2910 (FIG. 29), a wall, roof, flooring, ceiling, box truck walls, shipping containers, ice fishing houses, RV floors or other areas of a temporary shelter 3010 (FIG. 30).

In certain embodiments, the core layers, skin layers and/or thermoplastic composite articles described herein can be present in a structural panel. The structural panel can be used, for example, as sub-flooring, wall sheathing, roof sheathing, as structural support for cabinets, countertops and the like, as stair treads, as a replacement for plywood and other applications. If desired, the structural panel can be coupled to another substrate such as, for example, plywood, oriented strand board or other building panels commonly used in residential and commercial settings. Referring to FIG. 31, a top view of a structural panel 3110 is shown. The panel 3110 may comprise any one or more of the core layers, porous layers, skin layers and/or reinforcement layers described herein. If desired, two or more structural panels can be sandwiched with a skin facing into the interior of the room and another skin of the other structural panel facing outward away from the interior of the room. In some instances, the structural panel may also comprise a structural substrate 3220 as shown in FIG. 32. The exact nature of the structural substrate 3220 may vary and includes, but is not limited to, plywood, gypsum board, wood planks, wood tiles, cement board, oriented strand board, polymeric or vinyl or plastic panels and the like. In some examples, the structural substrate comprises a plywood panel, a gypsum board, a wood tile, a ceramic tile, a metal tile, a wood panel, a concrete panel, a concrete board or a brick. If desired, the structural panel may further comprise a second structural panel coupled to a skin layer of the first structural panel. The fiber reinforcement layer may be facing an open environment such that impact resistance can be provided to the structural panel.

In certain instances, the core layers, porous layers, skin layers and/or reinforcement layers described herein can be present in a wall board or wall panel. The wall panel can be used, for example, to cover studs or structural members in a building, to cover ceiling joists or trusses and the like. If desired, the wall panel can be coupled to another substrate such as, for example, tile, wood paneling, gypsum, concrete backer board, or other wall panel substrates commonly used in residential and commercial settings. Referring to FIG. 33, a side view of a wall panel 3300 is shown. The panel 3300 may comprise one or more of the core layers, skin layers and/or fiber reinforcement layers described herein. For example, the wall panel 3300 may also comprise at least one reinforcement layer 3320 with an angled arrangement of fibers coupled to a first surface of a porous layer 3310. While not shown, a core layer may coupled to another surface of the porous layer 3310. An optional wall substrate can be coupled to a second surface of the porous layer 3310 (or the core layer when present) and is configured to support the wall panel 3300 when coupled to a wall surface. In certain configurations, the wall panel 3300 further comprises a decorative layer disposed on the layer 3320. In certain embodiments, a second wall panel can be coupled to the panel 3300 if desired.

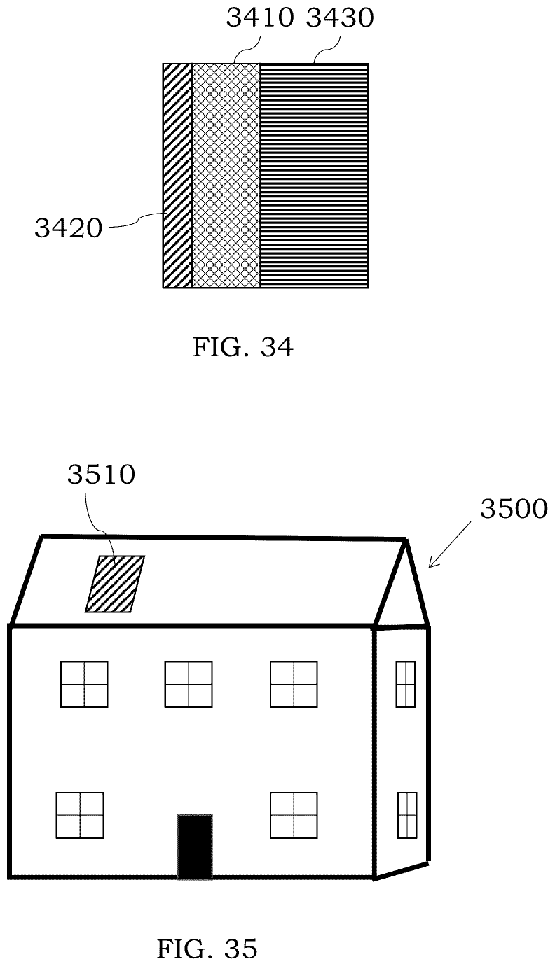

In certain instances, the core layers, reinforcement layers and/or thermoplastic composite articles described herein can be present in a siding panel to be attached to a building such as a residential home or a commercial building. The siding panel can be used, for example, to cover house wrap, sheathing or other materials commonly used on outer surfaces of a building. If desired, the siding panel can be coupled to another substrate such as, for example, vinyl, concrete boards, wood siding, bricks or other substrates commonly placed on the outside of buildings. Referring to FIG. 34 a side view of a siding panel is shown. The panel may comprise any one or more of the core layers, fiber reinforcement layers, porous layers and/or thermoplastic composite articles described herein, e.g., a porous layer 3410 and a reinforcement layer 3420. A core layer 3430 can couple to a covering which may be vinyl, wood, brick, concrete, etc. For example, a vinyl substrate can be coupled to the core layer 3430, and the siding can be configured to couple to a non-horizontal surface of a building to retain the siding panel to the non-horizontal surface of the building. In some instances, the siding panel further comprises a weather barrier, e.g., house wrap, a membrane, etc. coupled to a second surface of the flame retardant and noise reducing layer. In some embodiments, the substrate comprises a nailing flange to permit coupling of the siding to the side of the building. In some examples, the siding panel may further comprise a second siding panel and can be coupled to a second substrate. In some cases, a butt joint, overlapping joint, etc. may exist where the two siding panels can horizontally lock into each other. The reinforcement layer 3420 may be exposed to the environment to provide impact resistance to the siding panel.

In certain instances, the core layers, porous layers, reinforcement layers and/or thermoplastic composite articles described herein can be present in a roofing panel to be attached to a building such as a residential home or a commercial building. The roofing panel can be used, for example, to cover an attic space, attach to roof trusses or cover a flat roof as commonly present in commercial buildings. If desired, the roofing panel can be coupled to another substrate such as, for example, oriented strand board, plywood, or even solar cells that attach to a roof and function to cover the roof. Referring to FIG. 35, a perspective view of a roofing panel 3510 attached to a house 3500 is shown. The roofing panel 3510 may comprise any one or more of the core layers, porous layers, reinforcement layers and/or thermoplastic composite articles described herein. If desired, two or more roofing panels can be sandwiched or otherwise used together. The roofing panel may also comprise a roofing substrate coupled to a first surface of a core layer and can be coupled to a roof of a building to retain the roofing panel to the roof. In some examples, the roofing panel may comprise, or be used with, a weather barrier, e.g., a membrane, house wrap, tar paper, plastic film, etc. In certain instances, the roofing panel comprises a second roofing panel or can be overlapped with, or coupled to, a second roofing panel to prevent moisture from entering into the house 3500. The roofing panel 3510 may be configured with the reinforcement layer exposed to the environment to provide impact resistance to the roofing panel 3510.

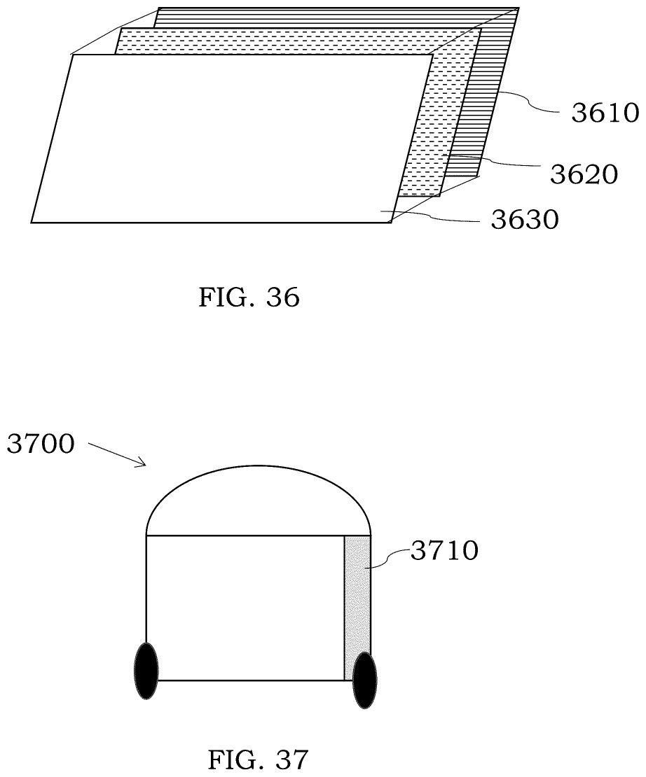

In certain configurations, the core layers, reinforcement layers and/or thermoplastic composite articles described herein can be present in a roofing shingle to be attached to a building such as a residential home or a commercial building to absorb sound and to provide flame retardancy. The roofing shingle can be used, for example, to cover a roof commonly present in residential and commercial buildings. If desired, the roofing shingle can be coupled to another substrate such as, for example, asphalt, ceramic, clay tile, aluminum, copper, wood such as cedar and other materials commonly found or used as roofing shingles Referring to FIG. 36, an exploded view of a roofing shingle is shown. The roofing shingle 3600 may comprise any one or more of the core layers, reinforcement layers and/or thermoplastic composite articles described herein. If desired, two or more roofing shingles can be sandwiched. In some examples, the roofing shingle may comprise a porous layer 3620 coupled to a core layer 3630 on one surface and coupled to a fiber reinforcement layer 3610 on another surface. If desired, a weatherproof roofing shingle substrate (not shown) can be coupled to the reinforcement layer 3610 to provide a weatherproof and/or flame retardant roofing panel. In certain instances, a weather barrier can be coupled to a roofing shingle. In other examples, the roofing shingle comprises asphalt. The reinforcement layer 3610 can be positioned upward toward the environment to provide impact resistance.

In certain configurations, any one or more of the core layers, porous layers, reinforcement layers and/or thermoplastic composite articles described herein can be present in an interior panel or wall of a recreational vehicle (RV) or an interior panel of an aircraft or aerospace vehicle, e.g., a rocket, satellite, shuttle or other airline or space vehicles. The panel or wall can be used, for example, to cover a skeleton structure on an interior side of the recreational or aerospace vehicle and may be coupled to foam or other insulation materials between the interior and exterior of the vehicle. In some examples, the core layers, porous layers, reinforcement layers, and/or thermoplastic composite articles described herein may be part of a sandwich structure formed from the core layer or article and other layers. If desired, the interior panel can be coupled to another substrate such as, for example, a fabric, plastic, tile, etc.

Referring to FIG. 37, a side view of a recreational vehicle 3700 is shown. The interior panel 3710 may comprise any one or more of the porous layers, core layers, reinforcement layers and/or thermoplastic composite articles described herein. If desired, two or more RV panels can be sandwiched or coupled together. In some examples, an RV panel may comprise an interior wall substrate that is configured as a decorative layer such as a fabric, a plastic, tile, metal, wood or the like. In additional instances, the RV panel comprises a second RV interior panel which can be the same or different from the RV panel. If desired, the RV panel may comprise a third RV interior panel which may also be the same or different. While not shown, a similar interior panel can be present in aerospace applications/vehicles and may be placed against and/or coupled to an exterior skin such as a metal or metal alloy skin or structure, e.g., aluminum, magnesium, titanium, etc. or other exterior structure. In certain embodiments, the reinforcement layer can be exposed to an interior space of the vehicle to provide impact resistance.

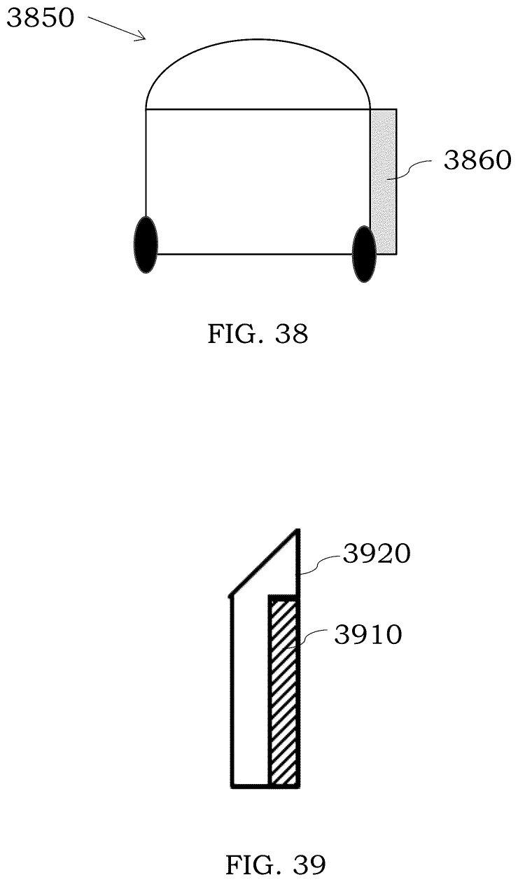

In certain configurations, any one or more of the core layers, reinforcement layers and/or thermoplastic composite articles described herein can be configured as, or present in, an exterior panel or wall of an aircraft vehicle, an aerospace vehicle or a recreational vehicle. The panel or wall can be used, for example, to cover a skeleton structure on an exterior side of the vehicle and may be coupled to foam or other insulation materials between the interior and exterior of the vehicle. In some examples, the core layer or article may be part of a sandwich structure formed from the core layer or article and other layers. If desired, the exterior panel can be coupled to another substrate such as, for example, a metal, a metal alloy, fiberglass, etc. Referring to FIG. 38, a side view of a recreational vehicle 3850 is shown that comprises an exterior panel 3860, which can be configured with any one of the porous layers, core layers, reinforcement layers and/or thermoplastic composite articles described herein. If desired, two or more RV panels can be sandwiched with a skin facing into the interior of the RV and a skin of the other RV panel facing outward away from the interior of the RV. In certain configurations, the exterior wall substrate comprises glass fibers or is configured as a metal panel such as aluminum or other metal materials. If desired, the reinforcement layer can be placed adjacent to the exterior wall substrate to enhance impact resistance. In additional instances, the RV panel comprises a second RV exterior panel which can be the same or different from the RV panel. If desired, the RV panel may comprise a third RV exterior panel which may also be the same or different. While not shown, a similar exterior panel can be present in aerospace applications/vehicles and may be placed against and/or coupled to an interior skin or structure such as an interior metal or metal alloy skin, e.g., aluminum, magnesium, titanium, etc., or other interior structure.

In some examples, the core layers, reinforcement layers and/or thermoplastic composite articles described herein can be used as interior trim applications, e.g., RV interior trim, interior trim for building or for automotive applications. The interior trim can be coupled to other materials, such as, for example, wood, PVC, vinyl, plastic, leather or other materials. A side view illustration of a trim piece that can be used as baseboard trim is shown in FIG. 39. The trim piece comprises a trim substrate 3920, which can include a reinforcement layer, a porous layer, a core layer and optionally other layers. The trim piece may be nailed or otherwise attached to a stud or wallboard 3910 as desired. The reinforcement layer of the substrate 3920 faces outward and is viewable within a room. The reinforcement layer can be covered with a decorative layer or a skin layer if desired, The trim piece can be curved or may take two or three dimensional shapes as desired.

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, configurations, examples and embodiments have been described above, it will be recognized by the person of ordinary skill in the art, given the benefit of this disclosure, that additions, substitutions, modifications, and alterations of the disclosed illustrative aspects, configurations, examples and embodiments are possible.

1. A thermoplastic composite article comprising:
a core layer comprising a foam material;
a porous layer comprising a web of reinforcing fibers held in place by a thermoplastic material, wherein the porous layer is disposed on a first surface of the core layer; and
a fiber reinforcement layer assembly disposed on the porous layer, wherein the fiber reinforcement layer assembly comprises a matrix comprising a plurality of arranged fibers held in place by an amorphous thermoplastic material.

2. The thermoplastic composite article of claim 1, wherein the plurality of arranged fibers of the fiber reinforcement layer assembly comprise a unidirectional arrangement of the fibers in a single ply, two plys, three plys, four plys, five plys, six plys or more than six plys.

3. The thermoplastic composite article of claim 2, wherein the plurality of arranged fibers of the fiber reinforcement layer assembly are selected from the group consisting of glass fibers, carbon fibers, organic fibers, inorganic fibers, bicomponent fibers, and combinations and blends thereof.

4. The thermoplastic composite article of claim 1, wherein the plurality of arranged fibers of the fiber reinforcement layer assembly comprise a bidirectional arrangement of the fibers in a single ply, a bidirectional arrangement of the fibers in two plys, a bidirectional arrangement of the fibers in three plys, a bidirectional arrangement of the fibers in four plys, a bidirectional arrangement of the fibers in five plys, a bidirectional arrangement of the fibers in six plys or a bidirectional arrangement of the fibers in more than six plys.

5. The thermoplastic composite article of claim 4, wherein the plurality of arranged fibers of each ply are independently selected from the group consisting of glass fibers, carbon fibers, organic fibers, inorganic fibers, bicomponent fibers and combinations and blends thereof.

6. The thermoplastic composite article of claim 1, wherein the fiber reinforcement layer assembly comprises a basis weight between 400 gsm and 4000 gsm.

7. The thermoplastic composite article of claim 6, wherein the fiber reinforcement layer assembly comprises four plys comprising a 0/90/90/0 arrangement of the plurality of the arranged fibers.

8. The thermoplastic composite article of claim 7, wherein the thermoplastic material of the each of the four plys of the fiber reinforcement layer assembly each is independently an amorphous polyethylene terephthalate or an amorphous polyolefin.

9. The thermoplastic composite article of claim 1, wherein the thermoplastic material of the porous layer comprises at least one of a polyethylene, a polypropylene, a polystyrene, a polyimide, a polyetherimide, an acrylonitrylstyrene, a butadiene, a polyethylene terephthalate, a polybutyleneterephthalate, a polybutylenetetrachlorate, a polyvinyl chloride, a polyphenylene ether, a polycarbonate, a polyestercarbonate, a polyester, an acrylonitrile-butylacrylate-styrene polymer, an amorphous nylon, a polyarylene ether ketone, a polyphenylene sulfide, a polyaryl sulfone, a polyether sulfone, a poly(1,4 phenylene) compound, a silicone and mixtures thereof.

10. The thermoplastic composite article of claim 1, wherein the reinforcing fibers of the porous layer are selected from the group consisting of glass fibers, carbon fibers, graphite fibers, synthetic organic fibers, inorganic fibers, bicomponent fibers, natural fibers, mineral fibers, metal fibers, metalized inorganic fibers, metalized synthetic fibers, ceramic fibers, and combinations and blends thereof.

11. The thermoplastic composite article of claim 1, further comprising a second porous layer between the core layer and the porous layer.

12. The thermoplastic composite article of claim 11, further comprising a first adhesive layer between the fiber reinforcement layer assembly and the porous layer and a second adhesive layer between the porous layer and the core layer.

13. The thermoplastic composite article of claim 12, wherein each of the first adhesive layer and the second adhesive layer comprises a polyolefin.

14. The thermoplastic composite article of claim 13, wherein the plurality of arranged fibers of the fiber reinforcement layer assembly comprise a unidirectional arrangement of the fibers in a single ply, a bidirectional arrangement of fibers in two plys, a bidirectional arrangement of fibers in three plys, a bidirectional arrangement of fibers in four ply, or a bidirectional arrangement of fibers in more than four plys.

15. The thermoplastic composite article of claim 14, wherein the plurality of arranged fibers of the skin are selected from the group consisting of glass fibers, carbon fibers, organic fibers, inorganic fibers, bicomponent fibers, and combinations and blends thereof.

16. The thermoplastic composite article of claim 13, wherein the foam material of the core layer comprises an expandable foam, an expandable polyurethane foam, or an expandable polystyrene foam.

17. The thermoplastic composite article of claim 13, wherein the foam material of the core layer comprises a high density polyethylene terephthalate foam.

18. The thermoplastic composite article of claim 1, further comprising a support layer coupled to a second surface of the core layer.

19. The thermoplastic composite article of claim 18, wherein the support layer comprises a metal layer, a porous layer, a glass mat, a flame retardant panel, a scrim, or a fiber reinforcement layer assembly.

20. The thermoplastic composite article of claim 1. wherein the amorphous thermoplastic material of the fiber reinforcement layer assembly is polyolefin free.

21-31. (canceled)
